(19) United States
(12) Patent Application Publication
(10) Pub. No.: US 2005/0240646 A1
(43) Pub. Date: Oct. 27, 2005

(54) Reconfigurable matrix multiplier architecture and extended borrow parallel counter and small-multiplier circuits

(75) Inventor: Rong Lin, Geneseo, NY (US)

Correspondence Address: DILWORTH & BARRESE, LLP, 333 EARLE OVINGTON BLVD., UNIONDALE, NY, 11553, US

(73) Assignee: THE RESEARCH FOUNDATION OF STATE UNIVERSITY OF NEW YORK, ALBANY, NY (US)

(21) Appl. No.: 10/830,766

(22) Filed: Apr. 23, 2004

(51) Int. Cl. G06F 7/52

(52) U.S. Cl. 708/607

(57) ABSTRACT

A dynamically or run-time reconfigurable matrix multiplier architecture with a reconfiguration mechanism for computing the product of matrices Xp×r and Yr×q for any integers p, q, r and any item precision b, i.e., bitwidth, ranging from 4 to 64 bits is described. The reconfigurable matrix multiplier uses borrow parallel counters with new circuits, 6_{—}0, and 6_{—}1 and the improved small multiplier library. The reconfigurable matrix multiplier architecture is based on a novel scheme of trading data bitwidth for processing array or matrix size. The matrix multiplier achieves an extra compact, low power, high speed design through the use of a borrow parallel counters and a library of small borrow parallel multiplier circuits. The matrix multiplying processor using area comparable with a single 64×64-b multiplier constructed of very large-scale integrated (VLSI) circuits, can be reconfigured to produce the product of two matrices X(4×4) and Y(4×4) of 8, 16, and 32-bit data items in every 1, 4, and 16 pipeline cycles, respectively, or the product of two 64-b numbers in every pipeline cycle.

### GOVERNMENT RIGHTS

This invention was funded, at least in part, under grants from the National Science Foundation, No. CCR-0073469 and New York State Office of Advanced Science, Technology & Academic Research (NYSTAR, MDC) No. 1023263. The Government may therefore have certain rights in the invention.

### BACKGROUND OF THE INVENTION

1. Field of the Invention

The present invention relates generally to very large-scale integrated (VLSI) circuits and more specifically to cost effective, high-performance, dynamically or run-time reconfigurable matrix multiplier circuits having a reduced design complexity and borrow parallel counter and small multiplier circuits.

2. Description of the Related Art

Many matrix multipliers or matrix multiplication processors and related arithmetic architectures have been proposed in publications in the last two decades. Those publications include L. Breveglieri and L. Dadda, “A VLSI Inner Product Macrocell”, IEEE Transactions on VLSI Systems, vol. 6, No. 2, June 1998; L. Dadda, “Fast Serial Input Serial Output Pipelined Inner Product Units”, Dep. Elec. Eng. Inform. Sci. Politecnico di Milano, Italy, Milano, Italy, Internal Rep. 87-031, 1987; H. T. Hung, “Why Systolic Architectures?”, Computer, Vol. 15, 1982, pp. 65-112 (hereinafter “H. T. Hung”); E. L. Leiss, “Parallel and Vector Computing”, McGraw-Hill, New York, 1995; R. Lin, Low-Power High-Performance Non-Binary CMOS Arithmetic Circuits, Proc. of 2000 IEEE Workshop on signal processing systems (SiPS), Lafayette, La., October, 2000. pp. 477-486. (hereinafter “RL6”); R. Lin and M. Margala, “Novel Design And Verification of a 16×16-b Self-Repairable Reconfigurable Inner Product Processor”, in Proc. of 12th Great Lakes Symposium on VLSI, NYC, April, 2002, the contents of which are incorporated herein by reference, (hereinafter “RL5”). However, due to the complexity and cost inefficiency, such as requiring a large amount of hardware for limited speed-up in processing, none has been implemented for widely successful use. One well-studied exemplary design of such architecture includes the systolic array matrix multipliers (see H. T. Hung).

What is needed is reconfigurable matrix multiplier architecture, such as that discussed in K. Bondalapati, and V. K. Prasanna, “Reconfigurable Meshes: Theory and Practice”, Proc. of Reconfigurable Architecture Workshop: International Parallel Processing Symposium, IT press Verlag, April 1997. Such architecture should be dynamically or run-time reconfigurable with a reconfiguration mechanism for computing the product of matrices ranging from 4 to 64 bits.

### SUMMARY OF THE INVENTION

The present invention describes a general dynamically or run-time reconfigurable matrix multiplier architecture with a reconfiguration mechanism for computing a product of matrices X(n×r) and Y(r×n), which describe dimensions of matrices, and any item precision or bitwidth b of matrix elements, i.e., bitwidth ranging from 4 to 64 bits, based on a novel scheme of trading data bitwidth for processing array or matrix size.

Additionally, the present invention teaches an efficient application for size-4 matrix operations, which are critical to graphics processing and an area-power-efficient implementation scheme utilizing novel parallel counter circuits called borrow parallel counters, which encode signals and borrow bits, i.e., bits weighted 2, as building blocks for simplified system constructions.

The present invention provides a matrix multiplying processor for a general matrix multiplier using hardware comparable with one 64×64 bit high precision multiplier that can be directly reconfigured to produce a product of two matrices in several different input forms. For example, producing the following products:
1. a product of X(2×2) and Y(2×2) of 32-bit items in every 2 pipeline cycles, i.e., the pipeline throughput (PT)=½. Items being input bits;
2. a product of X(4×4) and Y(4×4) of 16-bit items in every 4 pipeline cycles;
3. a product of X(8×8) and Y(8×8) of 8-bit items in every 8 pipeline cycles;
4. a product of X(16×16) and Y(16×1 6) of 4-bit items in every 16 pipeline cycles; and
5. a product of two 64-b numbers in every pipeline cycle.
   In a non-reconfigurable high precision system, usually performed by large multipliers, the first four operations require 2³, 2⁶, 2⁹, and 2¹² multiplications, respectively.

The inventive matrix multiplier or matrix multiplying processor is a special processor used for typical computer graphics applications having the same amount of hardware as one 64×64-b multiplier, and can be directly reconfigured to produce the following products:
1. a product of four 16-item square matrix pairs of 8-bit data in every 4 pipeline cycles;
2. a product of two matrices X(4×4) and Y(4×4) of 16-bit data in every 4 pipeline cycles;
3. a product of two matrices X(4×4) and Y(4×4) of 32-bit data in every 16 pipeline cycles; and
4. a product of two 64-b numbers in every pipeline cycle.
   In a non-reconfigurable high precision system, the first three operations require 2⁸, 2⁶, and 2⁶ multiplications respectively.

The inventive matrix multiplier consists of 64 (8×8) small multipliers, which make up a large percentage of the matrix multiplier's area. The efficiency of an 8×8 multiplier circuit greatly affects the overall performance of the inventive matrix multiplier. The borrow parallel counter circuitry of the invention enables the inventive matrix multiplier to have a realistic and efficient implementation of the large reconfigurable matrix multiplier in terms of all aspects of very large-scale integrated (VLSI) circuits' performance including speed, power, area, and test.

The traditional one hot out of 2^{k} lines integer encoding, where k>=2, has an advantage of using fewer hot lines in representing small integers, and is well suited for low-power applications. However, extra circuits and lines required for the conversion between the unary and binary signals prevent the generalized use of such encoding for low-power circuit applications. The parallel counter circuitry of this invention extends the borrow parallel counter circuits and borrow parallel small multiplier library design of the U.S. patent application Ser. No. 10/728,485 filed Dec. 5, 2003, the contents of which are incorporated herein by reference (hereinafter “RL0”). The proposed parallel counter circuitry utilizes 1-hot out of four line signal encoding and utilizes borrow bits, i.e., input bits weighted 2, in a unique way, effectively merging conversions and arithmetic operations into a single embedded full adder circuit. This leads to advantages not only in power consumption, but also in lessening the VLSI area.

The invention presents an alternative library of seven small multipliers, developed based on four borrow parallel counters including borrow parallel counter 5_1 and 5_1_1 circuits (see RL0) and the newly developed borrow parallel counter circuits 6_0, 6_1. The seven new small multipliers run faster than the previously proposed multipliers due to the use of the new borrow parallel counter circuits 6_0 and 6_1.

The inventive circuits provide a significant reduction in switching activities and (hot) data paths due to the majority of the transistors being gated by or used to pass the 4-b 1-hot signals. The circuits with 0.25 mm and 0.18 mm processes for the counters and the matrix multiplying processor have shown superiority, particularly in compactness of layout and power dissipation, compared with their traditional binary counterparts.

### BRIEF DESCRIPTION OF THE DRAWINGS

The foregoing and other objects, aspects, and advantages of the present invention will be better understood from the following detailed description of preferred embodiments of the invention with reference to the accompanying drawings that include the following:

FIG. 1a is a diagram of a 4×4 partial product matrix generated by two 4-bit numbers X and Y on a network with a matrix of AND gates;

FIG. 1b is a diagram of a product of two numbers X and Y generated by adding all weighted partial product bits in the diagonal directions;

FIGS. 1c and 1d are diagrams of an 8×8 partial product matrix, which is decomposed into four 4×4 matrices A-D, where data from two input numbers X and Y is duplicated and sent to the decomposed multipliers;

FIG. 2a is a diagram of a circuit structure of four multipliers A-D of FIG. 1 used for performing multiplication of two 8-bit numbers with four 4×4 multipliers and a 3-n 8-b adder;

FIG. 2b is a diagram of a circuit having two 4-bit input item matrices X(2×2) and Y(2×2) as for performing a matrix multiplication product Z(2×2)=XY;

FIG. 2c is a diagram of two structures that can be combined into a single reconfigurable matrix multiplier structure by adding two 1-bit controlled switches;

FIG. 3a is a diagram of a reconfigurable matrix multiplier of size (s, 4)′ and block 4-2, where s is equal to 16 or (16, 4)′;

FIG. 3b is a diagram of a level recursive extension of the matrix multiplying process, where a reconfigurable matrix multiplier of size (s, 4)′, where s is equal to 32 and (s/m)²=64 for base 4×4 multipliers;

FIG. 4a is a Q(n×n) matrix for n=8=2k, k=4 or a Q(8×8) matrix;

FIG. 4b is the diagram of a square-recursive-M of the Q(8×8) matrix of FIG. 4a;

FIG. 4c is a tree diagram of the square-recursive M of FIG. 4b as a leaf-array of a 3-level full-4-branch tree;

FIGS. 5a-5c are diagrams of a matrix multiplying processor using reconfigurable matrix multipliers with a base multiplier m=8, where s is equal to 16, 32, and 64 respectively;

FIG. 6a is an illustration of a M(n×n) matrix, where n=2^{k} and k=2;

FIG. 6b is a diagram of reconfiguration duplication switches and their states 1, 2, and 3 for inputs options 1, 2, and 3;

FIG. 6c is a diagram of a row-major ordering of items of a matrix (row-major-M) and a column-major ordering of items of a matrix (col-major-M) respectively of two linear arrays of ports;

FIG. 6d is a diagram of the conceptual duplication network of FIG. 6c that can be simplified significantly to obtain the actual duplication network when the reconfigurable structure is considered as a single unit;

FIG. 6e is a diagram of a square-recursive-M of an array of base multipliers;

FIG. 6f is a diagram of a duplication and distribution mechanism for a matrix multiplier of size (s, m)′=(32, 8)′;

FIG. 7 is a diagram of a complete matrix multiplier of size (32, 8) and its three input options for the corresponding matrix M of FIG. 6a;

FIG. 8a is a diagram of a matrix multiplication mechanism of X(4×4)*Y(4×4) of 8-bit items with input streams and switch states C=01, C1=0, and C2=0;

FIG. 8b is a diagram of a square-recursive matrix multiplication mechanism process of the matrix multiplier shown in FIG. 6f;

FIG. 9a is a diagram showing a matrix multiplication mechanism of X(2×2)*Y(2×2) of 16-bit items with an input stream and switch states C=10, C1=1, C2=0;

FIG. 9b is a diagram showing steps performed by the matrix multiplication mechanism of FIG. 9a;

FIG. 10a is a diagram of an implementation of a matrix multiplication mechanism for multiplying two 32-b numbers, with C=11, C1=1, C2=1, and C set to state 3, option 3;

FIG. 10b is a diagram of a conceptual view of the matrix multiplication mechanism of FIG. 10a;

FIG. 11 is a diagram of a typical partitioning of input of b-bit item matrices X and Y;

FIG. 12 is a diagram of a complete matrix multiplier of size (s, m)=(64, 8) created by adding a duplication and a distribution networks to the matrix multiplier of FIG. 5c;

FIGS. 13a-13e are diagrams of a reconfigurable duplication network of matrix multiplier of size (64, 8);

FIG. 14a is a diagram of pipelined data flows and accumulations for the operation option 0 of the matrix multiplier (64, 8), with four pairs of 4×4 (8-bit) matrix multiplications in parallel when C=00 and W=UV;

FIG. 14b is a diagram of a conceptual view of the computation of W(4×4)=U(4×4)*V(4×4) in every 4 cycles in accordance with Equation E (in 4 pipeline steps);

FIG. 15 is a diagram of a full adder circuit, which adds two bits encoded in 4-b 1-hot forms, s0 and s1, and a binary bit Q without a type conversion;

FIG. 16a is a diagram of a parallel counter designated borrow parallel counter 5_1 circuit;

FIG. 16b is a diagram of a parallel counter designated borrow parallel counter 5_1_1 circuit,

FIG. 17 is a diagram of a typical application of a borrow parallel counter 5_1/5_1_1 circuits;

FIG. 18a is a diagram of a parallel counter designated borrow parallel counter 6_0 circuit;

FIG. 18b is a diagram of a parallel counter designated borrow parallel counter 6_1 circuit;

FIG. 19a is an existing 3:2 shift switch parallel counter;

FIG. 19b is a 3:2 shift switch parallel counter of the present invention

FIG. 19c is the 3:2 shift switch parallel counter shown in FIG. 19b designed for us with borrow parallel counter 6_0 and 6_1 circuits of FIGS. 18a and 18b.

FIGS. 20a to 20g are a library of small multipliers using 4-b 1-hot parallel counter circuits.

FIG. 21 is a diagram of an (8×8) small borrow parallel multiplier, which is an array with ten of borrow parallel counter 5_1 and 5_1_1 circuits and a number of supporting full adder 3:2 and half adder 2:2 counters; and

FIG. 22 is a diagram of pipelined matrix multipliers that can have layout (4-metal-layer) areas of 350×530=0.186 mm² and 420×2120=0.89 mm².

### DETAILED DESCRIPTION OF THE INVENTION

A novel approach of decomposing a partial product matrix, called square recursive decomposition, is described in R. Lin, “Reconfigurable Parallel Inner Product Processor Architectures”, IEEE Transactions on Very Large Scale Integration Systems (TVLSI), Vol. 9, No. 2. April, 2001. pp. 261-272 the contents of which are incorporated herein by reference, (hereinafter “RL3”); R. Lin, “Trading Bitwidth For Array Size: A Unified Reconfigurable Arithmetic Processor Design”, Proc. of IEEE 2001 International Symposium on Quality of Electronic Design, San Jose, Calif., March 2001, pp. 325-330; R. Lin, “A Reconfigurable Low-Power High-Performance Matrix Multiplier Architecture With Borrow Parallel Counters” Proc. of 10th Reconfigurable Architectures Workshop (RAW 2003), Nice France, April, 2003, the contents of which are incorporated herein by reference, (hereinafter “RL1”); and R. Lin, “Borrow Parallel Counters And Borrow Parallel Small Multipliers, New Technology Disclosure Documrentation”, Research Foundation of SUNY, August, 2002, the contents of which are incorporated herein by reference; (hereinafter “RL2”).

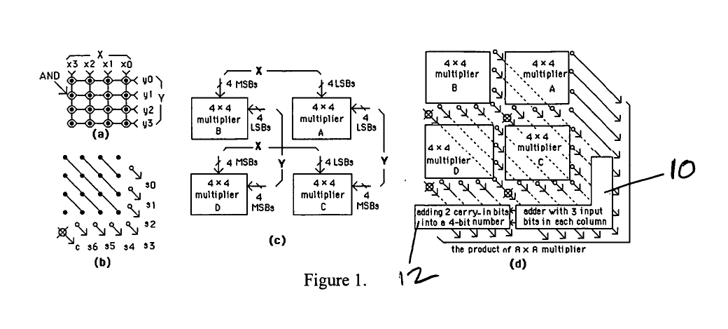

The decomposition of partial product matrix approach is briefly reviewed below with reference to FIG. 1. FIG. 1a shows a 4×4 partial product matrix generated by two 4-bit numbers X and Y in a network with a matrix of AND gates. FIG. 1b illustrates that the product of X and Y is generated by adding all weighted partial product bits in the diagonal directions. Each bit of the final sum or the product is then indicated by a small circle s0-s6 and the carry bit “c” is indicated by a circle marked by crossed lines.

The four multipliers are used to compute a product of two 8-bit numbers. FIGS. 1c and 1d conceptually show an 8×8 partial product matrix, which is decomposed, into four 4×4 matrices A-D, where the data from the two input numbers X and Y is duplicated and sent to the decomposed multipliers. FIG. 1d in particular shows that the weighted bits of the four products of the four multipliers are added by two adders to result in the final product of the 8×8 multiplier. The first adder 10 receives exactly three bits in each of its eight columns along the diagonal direction. The second adder 12 receives one bit per column and two carry-in bits from the first adder. This process is equivalent to direct addition of partial products, therefore the result is the product of X and Y.

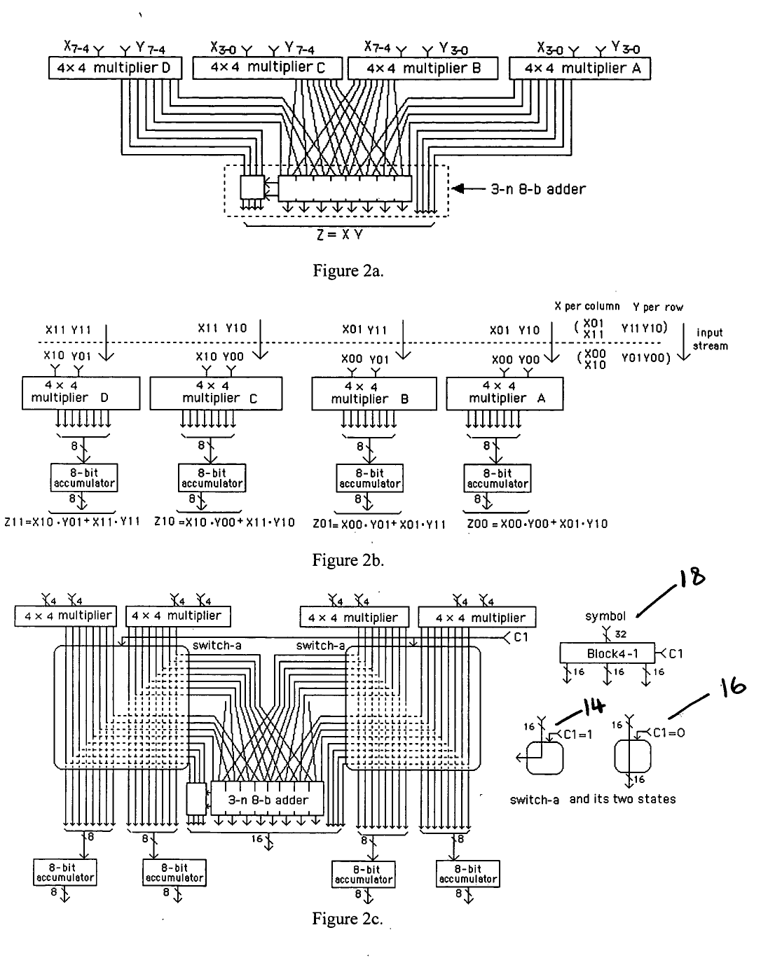

Two types of computations and the reconfigurable matrix multiplying processor are illustrated in FIGS. 2a-c. FIG. 2a shows a circuit structure of the four multipliers (A-D) of FIG. 1 used for performing multiplication of two 8-bit numbers with four 4×4 multipliers and a 3-n 8-b adder. It is easy to see that the process implements the right part of the following algebraic equation:

$${\sum }_{0 \leq i , j \leq 7} {X}_{i} {Y}_{j} {2}^{i + j} = {\sum }_{0 \leq u , v \leq 1} {\sum }_{\begin{matrix}4 u \leq i \leq 3 + 4 u \\ 4 v \leq j \leq 3 + 4 v\end{matrix}} {X}_{i} {Y}_{j} {2}^{i + j} \qquad ( E1 )$$

Here X and Y are two 8-bit numbers, where X=X7 . . . . Xi . . . X0, Y=Y7, i and j are indices of matrix elements and u and v for 0≦u, v≦1 lower integers, imply the addition of or a square of four weighted 8-b numbers having respective weights of 1, 2⁴, 2⁴, and 2⁸, by an adder called a 3-n adder that involves adding 3 numbers due to the weight difference.

As illustrated in FIG. 2b, considering that if the inputs are two 4-bit item matrices X(2×2) and Y(2×2) and the desired computation is the matrix multiplication product Z(2×2)=XY, it is easy to verify that the same pipelined architecture with accumulators added, can do the job. X, Y, and Z are all 8-bit items. It is also easy to verify that the process implements the right part of the following algebraic equation:

$${Z}_{ij} = {\sum }_{0 \leq k \leq 1} {X}_{ik} {Y}_{kj} for 0 \leq i , j \leq 1 \qquad ( E2 )$$

Here Xᵢₖ and Yₖⱼ are 4-bit numbers. Since the numbers are weighted the same, 3-n addition is not required.

As is illustrated in FIG. 2c, the two structures can be combined into a single reconfigurable matrix multiplier structure by adding two 1-bit controlled switches. The product of two 8-bit numbers is produced by setting a C1 signal 14 to 1, and the product of two 4-bit item matrices X(2×2) and Y(2×2) is produced by setting the C1 signal 16 to 0. A block 4-1 symbol 18 is used by the reconfigurable matrix multiplier or matrix multiplying processor with excluded accumulators.

Construction of General Reconfigurable Matrix Multipliers

The reconfigurable matrix multiplying processor described above can be denoted by (s, m)′=(8, 4)′, where m represents the size of a base multiplier, s represents the matrix multiplier processor size that is equal to sqrt [(# of base multipliers)*m]. The prime sign is used to indicate that the matrix multiplier is not complete. A complete matrix multiplying processor will be discussed below. The approach of decomposing a larger partial product matrix into smaller product matrices and reconfiguring them for multiple types of computation may be applied recursively to construct a large size matrix multiplying processor. For example, four pieces of block 4-1, a 3-n 16-b adder, and corresponding large accumulators plus a few additional switches controlled by bit C2 will be sufficient to construct such a matrix multiplying processor with (s, m)′((16, 4)′.

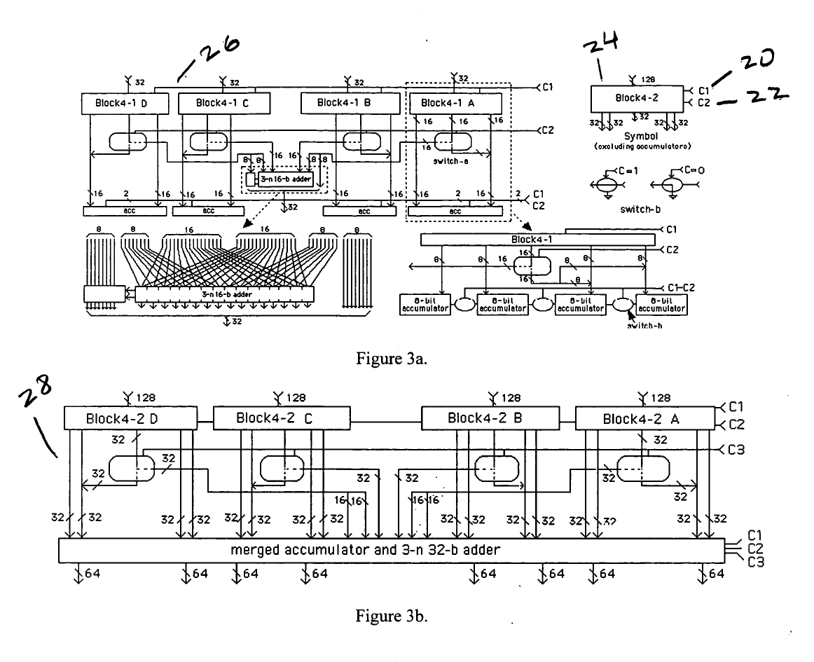

FIG. 3a illustrates a reconfigurable matrix multiplier 26 of (s, 4)′, with s being equal to 16 or (16, 4)′ and block 4-2 24. Some output lines are shared by two contiguous blocks, and it is easy to verify that the structure can produce the product of:
1. two numbers of 16 bits by setting both C1 20 and C2 22 to 1;
2. two 8-bit item matrices X(2×2) and Y(2×2) by setting C1=1, C2=0; or
3. two 4-bit items matrices X(4×4) and Y(4×4) by setting C1=C2=0.

It is also easy to verify that in general, if the matrix multiplier or matrix multiplying processor (s, m)′ is reconfigurable to compute the product of X(h×h) and Y(h×h) of b-bit items, then s=hb. As a special case, let h=1 then s=b, that means that the matrix multiplying processor (s, m)′ multiplies two s-bit numbers. So the size s of matrix multiplier (s, m)′ can also be seen as having the same size as an s-bit multiplier.

One more level recursive extensions of the matrix multiplying process is shown in FIG. 3b where a reconfigurable matrix multiplier 28 of (s, 4)′ with s equal 32 and (s/r)²⁼⁶⁴ of base 4×4 multipliers. The following products are produced with the described matrix multiplying processor:
1. a product of two 32-bit numbers;
2. a product of X(2×2) and Y(2×2) of 16-bit items;
3. a product of X(4×4) and Y(4×4) of 8-bit items; and
4. a product of X(8×8) and Y(8×8) of 4-bit items.

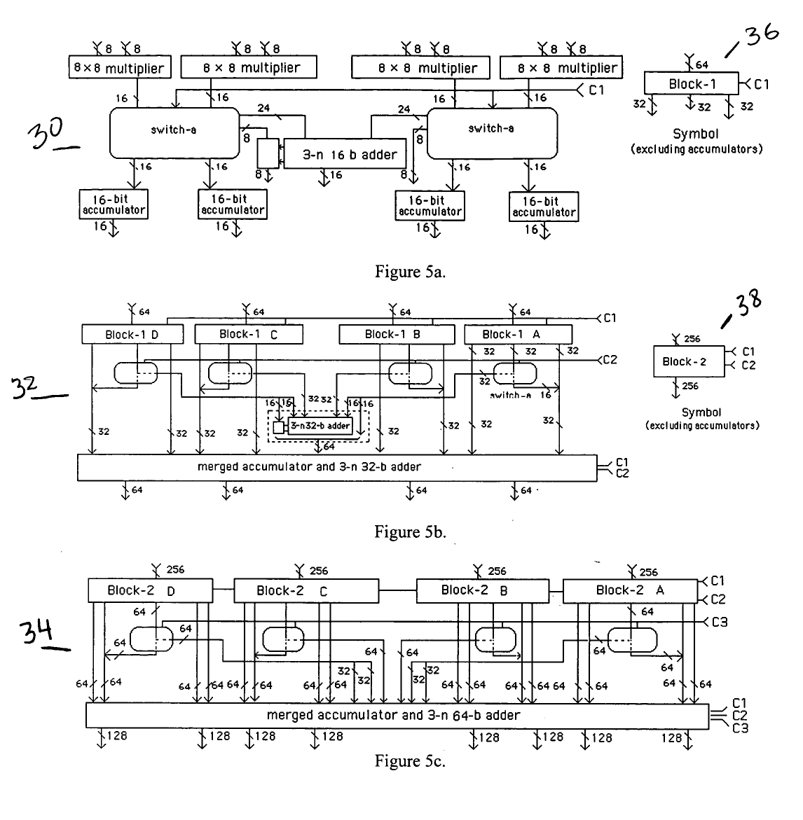

A similar matrix multiplying processor using reconfigurable matrix multipliers 30-34 with base multiplier m=8 are shown in FIGS. 5a-5c. Here, s is equal to 16 for the matrix multiplying processor 30 (FIG. 5a) and block-1 36, s is equal to 32 for the matrix multiplying processor 32 (FIG. 5b) and block-2 38, and s is equal to 64 for the matrix multiplying processor 34 (FIG. 5c). It can be easily seen that the followings products are produced with these matrix multiplying processors 30-34:
1. the product of two 64-bit numbers;
2. the product of 32-bit items X(2×2) and Y(2×2);
3. the product of 16-bit items X(4×4) and Y(4×4); and
4. the product of 8-bit items X(8×8) and Y(8×8).
   All operations are organized in pipelined forms and some output lines can be shared by two contiguous blocks. In addition, the last level adder and the accumulators can always be merged for efficiency.

Several data structures and components specific to the above described architecture can be defined. These data structures include three one-dimension arrays with respect to a given (n×n) matrix, an input reconfigurable duplication network, and a fixed data distribution network.

Definition 1

Given matrix Q(n×n)*(n=2k), a square recursive view of Q is a decomposition of Q as follows:

i. The top square, i.e., the matrix is substituted by four square directionally ordered in northeast (NE)->northwest (NW)->southeast (SE)->southwest (SW) sub-matrices, this process is then recursively applied until each sub-matrix is a number.
ii. With the process of square recursive view of Q, a full 4-branch tree can be constructed, the order of the leaf-items in the tree is defined as the square recursive order of matrix Q.
   Definition 2.

Given matrix Q(n×n)*(n=2k), one dimensional arrays, row-major ordering of items of matrix Q (row-major-Q), column major ordering of items of matrix Q (col-major-Q), and square recursive ordering of items of matrix Q (square-recursive-Q), each re-ordering of all items of matrix Q are defined as follows:
Let binary forms of i and j for (n−1≦i, j≦0) be i(k-1)i(k-2) . . . i(1)i(0) and j(k-1)j(k-2) . . . j(1)j(0) respectively, the indices of item Q(i, j) in row-major-Q, col-major-Q, and square-recursive-Q are respectively i*n+j, j*n+i and

$${\sum }_{0 \leq t \leq k - 1} ( i ( t ) * {2}^{2 t + 1} + j ( t ) * {2}^{2 t} )$$
or i(k-1)j(k-1)j(k-2)j(k-2) . . . i(1)j(1)i(0)j(0) in binary form.

Based on the Definitions 1 and 2, it can be verified that the square-recursive-Q is the array of the leaf-items of the tree constructed by following recursive view of Q, i.e., its items are in square recursive order.

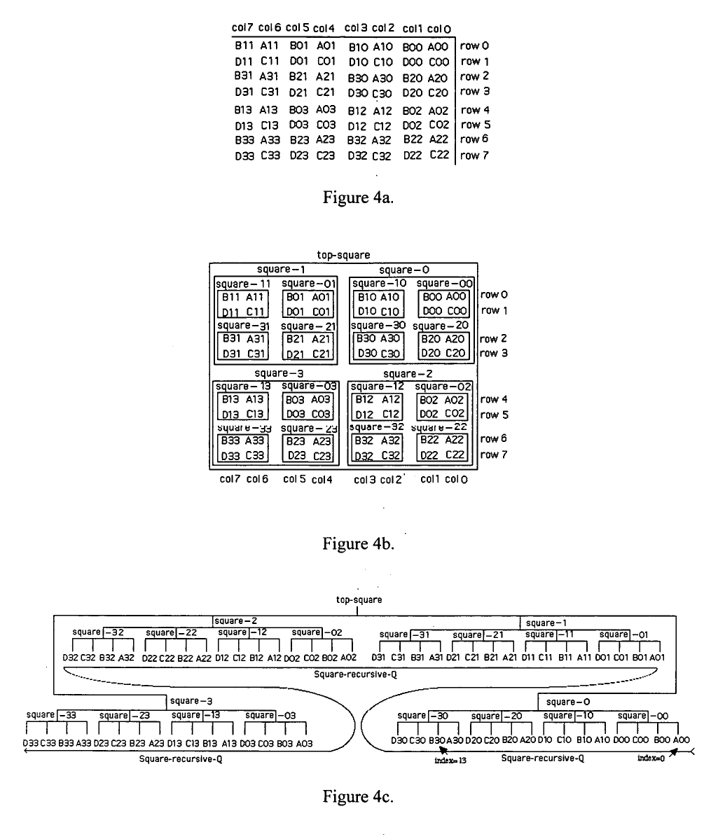

As an example consider a Q(n×n) matrix for n=4=2k, k=2 or a Q(4×4) matrix illustrated in FIG. 4a.
Q(0,3) Q(0,2) Q(0,1) Q(0,0)
Q(1,3) Q(1,2) Q(1,1) Q(1,0)
Q(2,3) Q(2,2) Q(2,1) Q(2,0)
Q(3,3) Q(3,2) Q(3,1) Q(3,0)

Here, row-major-Q with respect to matrix Q, Q(3, 0)=row-major-Q(3*4+0)=row-major-Q(12) is square recursive view of Matrix Q(n×n), for n=4. 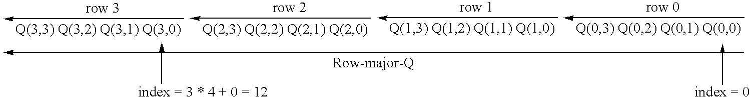
col-major-Q, with respect to matrix Q, Q(3, 0)=col-major-Q(0*4+3)=col-major-Q(3) is

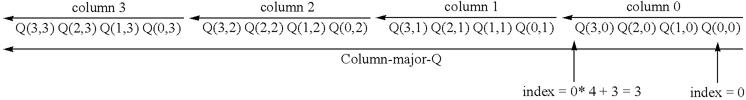

The top square, i.e., the matrix is substituted by four square ordered, i.e., NE-NW-SE-SW sub-matrices, which then recursively apply the process until each sub-matrix is an item. 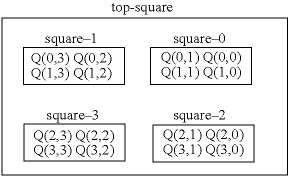
The square-recursive-Q, with respect to matrix Q, is the leaf-array of a 2-level full-4-branch tree constructed following the square recursive view of Q.

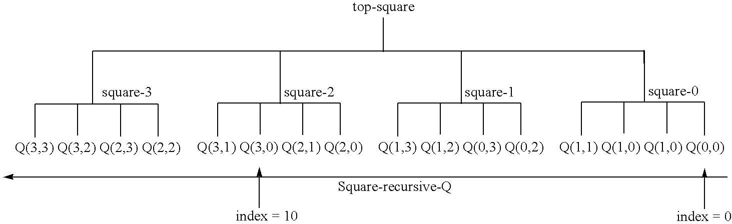

Here, indices: 3=011(2), 0=000(2), and Q(3, 0)=square-recursive-Q(001010(2))=square-recursive-Q(10). As with respect to matrix M(8×8) illustrated in FIG. 4a, the square-recursive-M is illustrated in FIG. 4b. The square-recursive M is the leaf-array of a 3-level full-4-branch tree illustrated in FIG. 4c. As can be seen, indices: 2=0102, 3=0112, and M(2, 3)=square-recursive-M(0011012)=square-recursive-M(13).

For a pipelined matrix multiplication to generate accumulated outputs only a row and a column from two input matrices respectively in each cycle are needed to be: provided. The input data stream is then needed to be duplicated and distributed to the matrix multiplier, using the following two additional simple sub-networks:
1. The input duplication sub-network with reconfiguration switches. For duplicating data received from fixed input ports for all three input options, then duplicating and outputting them in row-major and column-major orders to the row-major-M and col-major-M arrays of ports respectively.
2. The (fixed) distribution network which permutates data according to square (recursive) order to the square-recursive-M array of base multipliers. By attaching these two sub-networks to the matrix multiplying processor, the input network is complete.
   Definition 3—Duplication and Distribution Nets

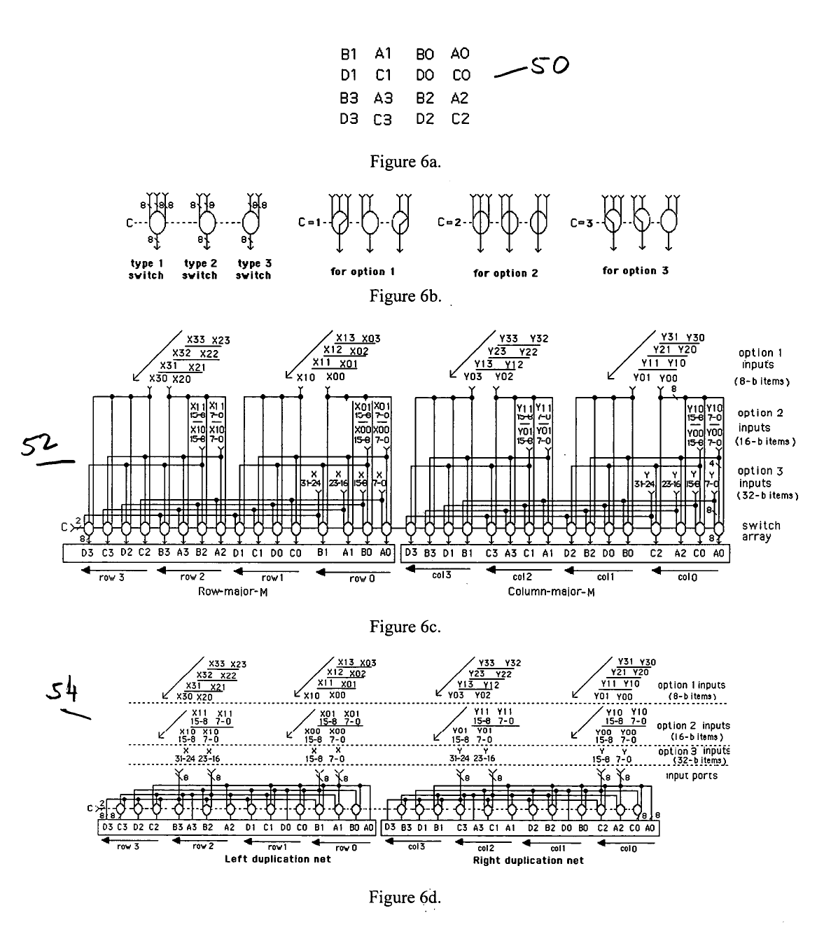

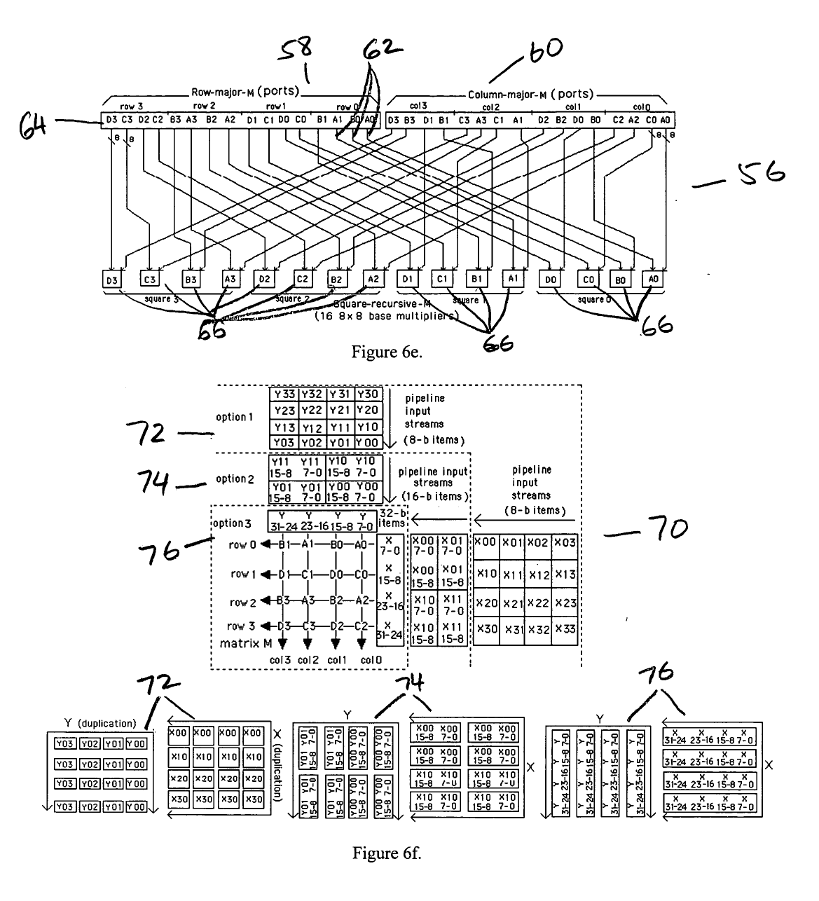

Matrix 50 is illustrated in FIG. 6a. FIG. 6b shows the reconfiguration duplication switches and their states 1, 2, and 3 for inputs options 1, 2, and 3 respectively. Given Matrix M(n×n) 50, where n=2k, for n=4, and assuming that row-major-M and col-major-M represent two linear arrays of ports 52 and 54 illustrated in FIGS. 6c and 6d respectively, and that square-recursive-M represents an array of base multipliers 56 illustrated in FIG. 6e. The reconfigurable duplication network is a circuit, which duplicates input data for desired operation options and sends them to row-major-M 58 and col-major-M 60. A distribution network is a set of fixed lines 62 which connect ports 54 of row-major-M 58 and col-major-M 60 to base multipliers 66 of square-recursive-M 56, so that each port is connected to the same name base multiplier. When the reconfigurable structure is considered as a single unit, the conceptual duplication network 52 (FIG. 6c) can be simplified significantly to obtain the actual duplication network 54 (FIG. 6d).

The topology of a reconfigurable duplication network is determined by the matrix M(n×n) and all preset input options. The topology of a distribution network is determined only by the value n of the matrix M(n×n).

The duplication and distribution mechanism for a matrix multiplier of (s, m)′=(32, 8)′ is illustrated in FIG. 6f using matrix form terms. The input duplication by the duplication network is shown in a matrix form 70.

Option 1 is identified by reference number 72, and represents a first step for the input duplication and distribution network, where X(4×4) and Y(4×4) have the total of 8-b items.

Option 2 is identified by reference numeral 74, and represents a first step for the input duplication and distribution network, where X(2×2) and Y(2×2) have the total of 16-b items.

Option 3 is identified by reference numeral 76, and represents a first step for the input duplication and distribution network, where X and Y have the total of 32-b items.

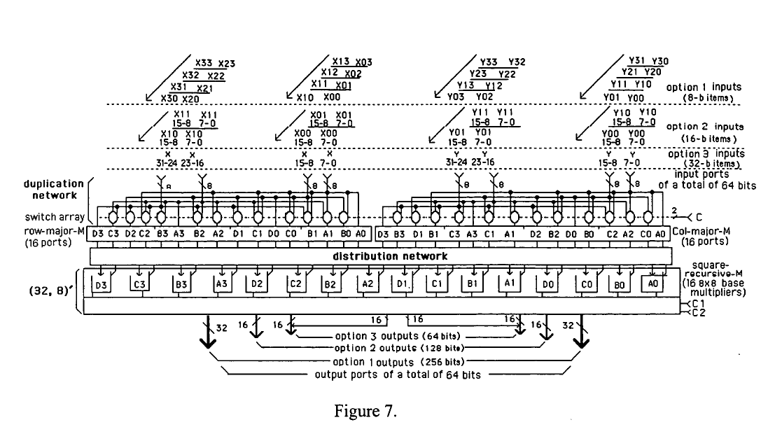

While FIG. 3 describes the incomplete (32, 8)′ matrix multiplier, FIG. 7 illustrates the complete (32, 8) matrix multiplier and its three input options for the corresponding matrix M described above with reference to FIG. 6a. Once the inputs are duplicated and distributed to the array of base multipliers, i.e., square-recursive-Q, the corresponding incomplete matrix multipliers or modules, described above with reference to FIGS. 3 and 5, can be used to perform a selected computation in a pipeline to yield desired results. The complete matrix multiplier denoted by (s, m) is a matrix multiplying processor that comprises:
1. a reconfigurable input duplication net, and
2. a fixed distribution net and the corresponding incomplete matrix multiplier (s, m)′.
   The Reconfigurable Matrix Multiplication Mechanism

The above discussion leads to a complete matrix multiplication mechanism. Considering Z(n×n)=X(n×n)*Y(n×n), the computation may be represented in an inner product form as Equation E:

$$\begin{matrix}{Z}_{ij} = {\sum }_{0 \leq k \leq n - 1} {X}_{ik} {Y}_{kj} \\ = {X}_{i0} {Y}_{0 j} + {X}_{i1} {Y}_{1 j} + … {X}_{ik} {Y}_{kj} … + {X}_{in - 1} {Y}_{n - 1 j} \\ = {Z}_{ij} ( 0 ) + {Z}_{ij} ( 1 ) + … {Z}_{ij} ( k ) … + {Z}_{ij} ( n - 1 ) 0 \leq i , j \leq n - 1\end{matrix} \qquad ( E )$$

or Z=XY=Z(0)+Z(1)+ . . . +Z(k)+ . . . +Z(n−1)
here X, Y, Z, Z(k) 0≦k≦n−1 are n×n matrices and Z(k)=(XᵢₖYₖⱼ)=(Zᵢⱼ(k).)

According to Equation E, the multiplier takes n steps to compute the value of Z(n), term by term and one term per step. At the k-th step the base multiplier at position (i, j) multiplies X(ik)*Y(kj) to yield the k-th term of the inner product, i.e., Z(ij)*(k) which is accumulated into the result of the previous steps. In the inventive matrix multiplying processor this computation occurs in parallel.

Equation E suggests that n² base multipliers are required. Since base multipliers are very small, for n and m, that are not too large, for example n≦16 and m≦8, such a matrix multiplying processor is of a common size. It can also be seen that Equations E1 and E2 presented above are equivalent forms of Equation E with terms computed in different ways.

Returning to FIG. 7, it can now be verified that for two given b-bit item matrices X(h×h) and Y(h×h), for three options of h-b pairs: 4-8, 2-16 and 1-32, the matrix multiplier of (32, 8)=(hb, 8) produces the product of XY as follows:
1. receives a column from X and a row from Y in each pipeline step;
2. duplicates;
3. distributes;
4. multiplies (by the base multipliers only);
5. adds partial products (according to the states of the reconfiguration switches); and
6. accumulates the results.

The pipeline process has a throughput of 1/h cycles and a latency of h+log(s/m) cycles.

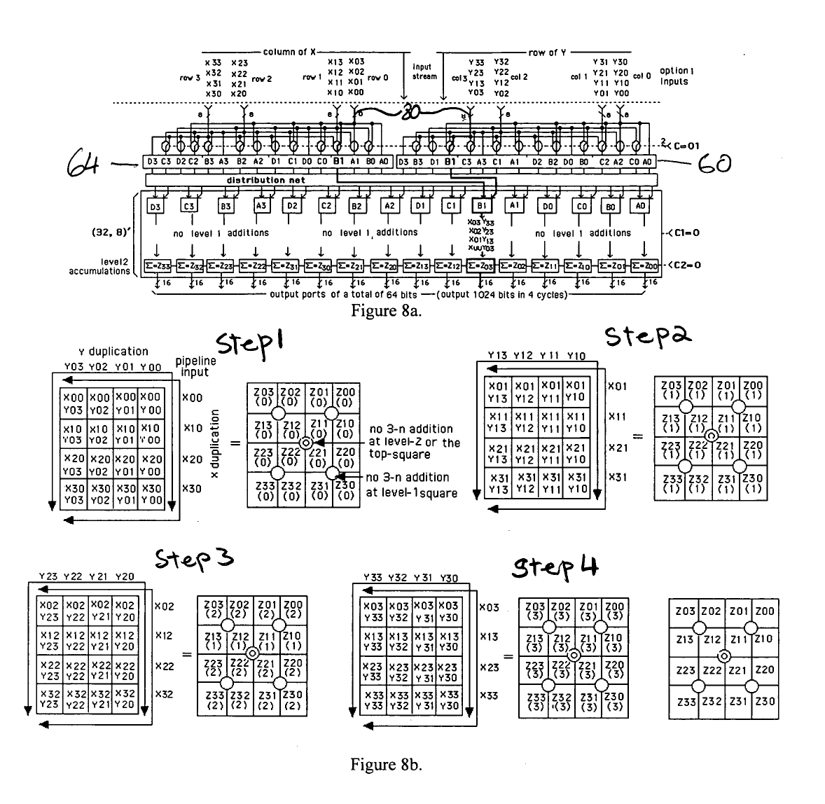

FIGS. 8a and 8b illustrate the process of X(4×4)*Y(4×4) of 8-bit items with input streams and switch states C=01, C1=0, and C2=0. Specifically, FIG. 8a shows an example of the implementation of the matrix multiplication mechanism. The reconfiguration switch state 1, option 1 input data are processed. The inputs of 8-bit items in each step of the pipelined stream consisting of a column from X(4×4) and a row from Y(4×4), are duplicated into 4 copies to yield a total of 32 (8-bit) items, which are distributed to the 16 (8×8) base multipliers, two items per multiplier. The bold lines 80 show that data is pipelined to base multipliers 60 and 64, and the products of (X₀₀)*(Y₀₃), (X₀₁)*(Y₁₃), (X₀₂)*(Y₂₃), (X₀₃)*(Y₃₃) are accumulated for Z₀₃ in four cycles. The bold lines 80 indicate that a stream of matrix item pairs (X₀₀)*(Y₀₃), (X₀₁)*(Y₁₃), (X₀₂)*(Y₂₃), (X₀₃)*(Y₃₃) is received by multiplier B1 and the products of the item pairs will be accumulated in add-accumulate modules to result in Z₀₃. All 16 base multipliers will produce 16 products of Zᵢⱼ for 0≦i, j≦3, in parallel, i.e., the process directly implements the right part of Equation E.

$${Z}_{ij} = {\sum }_{0 \leq k \leq 3} {X}_{ik} {Y}_{kj} for 0 \leq i , j \leq 3$$

Because the numbers are similarly weighted, there is no 3-n addition.

FIG. 8b illustrates the conceptual view of square-recursive illustration of the matrix multiplication mechanism process also shown in FIG. 6f. Four steps are performed. In step 1, 16 base multipliers in 16 entries yield the base. Step 2 is the same as Step 1 with new pipeline data; here, products are attained without 3-n addition (accumulation not shown). In each entry, one data item is the product of the base multiplier and, as shown, 8-b data is input to the base multiplier. Step 3 is similar to step 2, but uses new data. Finally, step 4 is the same as Step 3, but also uses new data. After accumulation, in each of the four steps, inputs are duplicated and distributed into base multipliers, which are entries of matrix M allocated in the array square-recursive-M.

The products of base multipliers are processed through two levels of 3-n additions associated with the two levels of squares to which they belong (this association is represented in FIG. 8b by a circle for level-1 and a double circle for level-2) and finally reaching the accumulators for accumulated results. The 3-n addition is not necessary and therefore is not performed. This minimizes the inventive architecture's inter-component connection because the square-recursive organization allows the 3-n adders at each level to associate with the data local only to them.

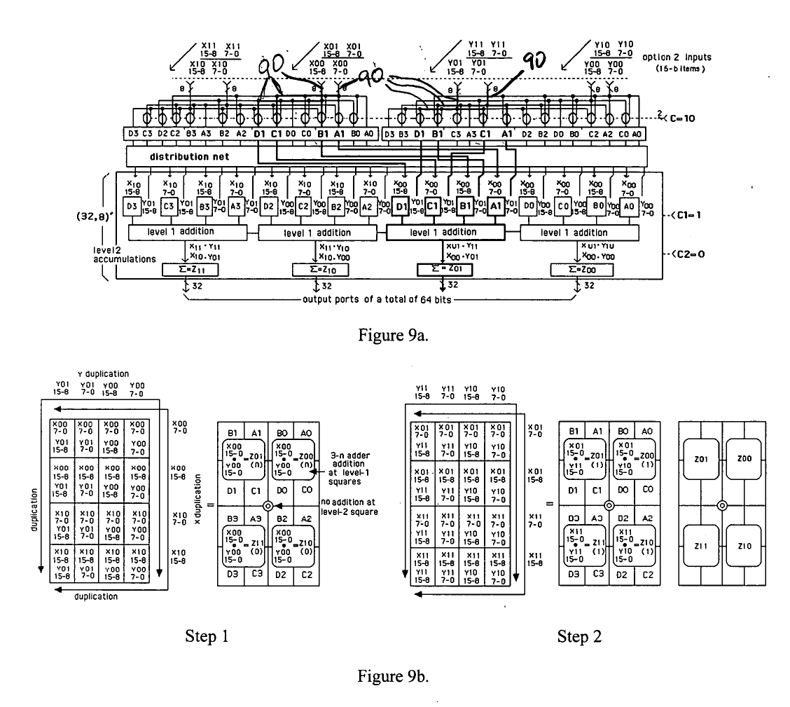

There are two more input options for the inventive matrix multiplying processor. For an input stream of 2×2 matrices of 16-bit items, C is set to state 2, option 2 data is processed, and the product of X(2×2)*Y(2×2) is produced. FIGS. 9a and 9b illustrate the process of X(2×2)*Y(2×2) of 16-bit items with an input stream and switch states C=10, C1=1, C2=0. Specifically; FIG. 9a shows the implementation view of a matrix multiplication mechanism. The bold lines 90 show data pipelined to 4 8×8 base multipliers A1, B1, C1, and D1 and producing two products, (X₀₀)*(Y₀₁) and (X₀₁)*(Y₁₁) obtained from level-1 addition in two pipeline cycles and then accumulated to result in Z₀₁. The operation implenments the right part of Equation E in the form, which is the combination of Equations E1 and E2.

$$\begin{matrix}{Z}_{ij} = {\sum }_{0 \leq k \leq 1} {X}_{ik} {Y}_{kj} \\ = {\sum }_{0 \leq k \leq 1} {\sum }_{0 \leq u , v \leq 1} {\sum }_{\begin{matrix}8 u \leq e \leq 8 u + 7 \\ 8 v \leq f \leq 8 v + 7\end{matrix}} {X}_{{ik}_{e}} {Y}_{{kj}_{f}} {2}^{e + f} for 0 \leq i , j \leq 1\end{matrix} \qquad ( E3 )$$

Here i, j, and k are used to index matrix elements; u, v, and e, f are used to index the binary bits of matrix elements for an outer level-2 sub-matrix and an inner level-1 sub-matrix, respectively. For example, Xᵢₖₑ 8u≦e≦8u+7 represents the e-th bit of matrix item Xᵢₖ for some value u. In particular, X over 0≦k≦1 implies a sum in two pipeline steps, X over 0≦u, v≦1 implies the 3-n addition of (a square) 4 weighted data, X over 8u≦e≦8u+7 and 8v≦f≦8v+7 for some u and v, the formation of a weighted base product by a base multiplier.

FIG. 9b illustrates the conceptual view of the matrix multiplication mechanism. In each of the two steps, inputs are duplicated and distributed into base multipliers (entries of matrix M). In step 1 base multiplications with 3-n addition at level-1 squares are performed. Step 2 is the same as Step 1 for new data and after accumulation. The products of the base multipliers are then processed through two levels of possible 3-n additions (only inner level addition is performed here), and finally reach the accumulators for accumulated results.

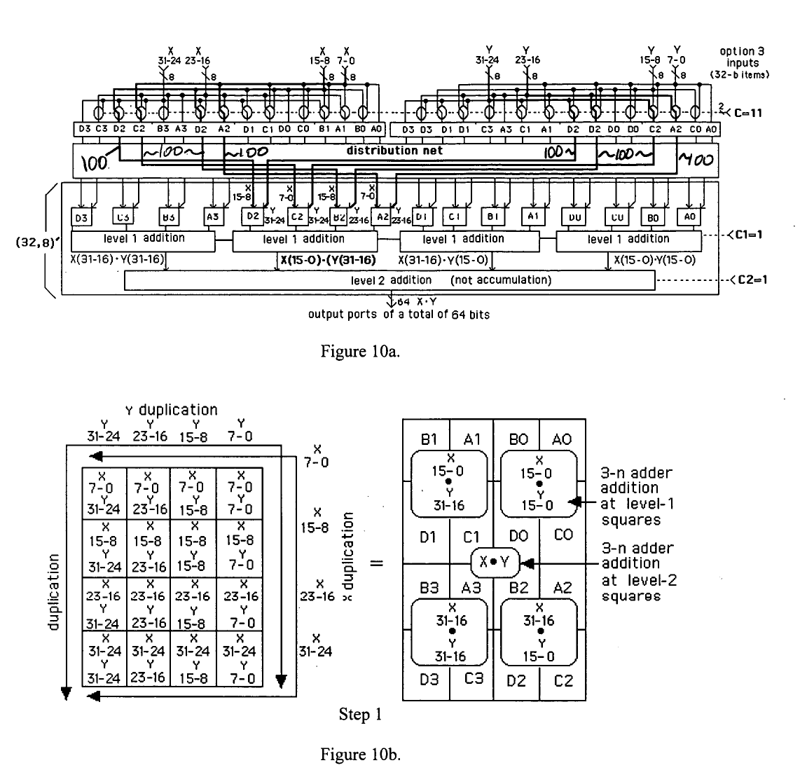

FIGS. 10a and 10b illustrate the process of multiplying two 32-b numbers, with C=11, C1=1, C2=1. For input of two 32-bit numbers, C is set to state 3, option 3 inputs are processed, and the product of two 32-b numbers is produced. Specifically, FIG. 10a shows the implementation view of a matrix multiplication mechanism. The bold line 100 indicates that products of X(0-3)*Y(8-11), X(4-7)*Y(8-11), X(0-3)*Y(12-15), and X(4-7)*Y (12-15) are added at level-1 to result in the product of X(0-7)*Y(8-15) and then sent to a level-2 module for addition, which results in the 64-b final product. The operation implements the right part of the following equation

$${\sum }_{0 \leq i , j \leq 32} {X}_{i} {Y}_{j} {2}^{i + j} = {\sum }_{0 \leq u , v \leq 1} {\sum }_{0 \leq e , f \leq 1} {\sum }_{\begin{matrix}16 u + 8 e \leq i \leq 16 u + 8 e + 7 \\ 16 v + 8 f \leq j \leq 16 v + 8 f + 7\end{matrix}} {X}_{i} {Y}_{j} {2}^{i + j} \qquad ( E4 )$$

This Equation is an extension of Equation E1. Here i and j are used as indices of bit positions of input numbers; u, v and e, f are used for outer-level and inner level decompositions, respectively. In particular, X over 0≦u, v≦1 implies the addition of an outer square of 4 weighted data sources by a 3-n adder, X over 0≦e, f≦1 implies the addition of an inner square of 4 weighted data sources by a 3-n adder, X over 16u+8e≦i≦16u+8e+7 and 16v+8f≦j≦16v+8f+7 for some u and v implies the formation of a weighted base 16-b product produced by the base multiplier.

FIG. 10b illustrates the conceptual view of a matrix multiplication mechanism. The inputs are duplicated and distributed into base multipliers (entries of matrix M). In the only step the mechanism performs base multiplications, addition at both level-1 and level-2 squares, and accumulation. The products of base multipliers are then processed through two levels of 3-n additions (3-n additions at both levels are required), and finally reach the accumulators for accumulated results.

Partitioning General Input Matrices

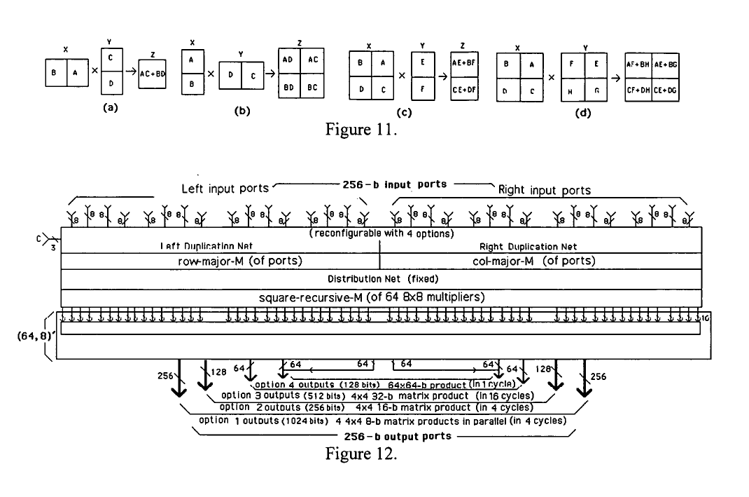

FIG. 11 illustrates typical partitioning of input matrices X and Y of b-bit items. Assuming the matrix multiplier is of size s, then each square represents an s/b×s/b sub-matrix. Given a matrix multiplier of (s, m), to compute the product of two general matrices X(n×r) and Y(r×n) for any desired item precision b (for an input parameter ranging from m to s), computer hardware or software may be used to partition the inputs into (s/b)×(s/b) sub-matrices which may then be sent to the matrix multiplier to be multiplied and accumulated in a pipelined fashion.

For example, using the matrix multiplier (32, 8) of FIG. 9, to compute the product of X(8×8) and Y(8×8) of 8-b items the partition of FIG. 1d can be used to create eight (4×4) sub-matrices: A, B, C, D, E, F, G, H and compute the product of A(4×4) and E(4×4), the product of B(4×4) and G(4×4) and accumulate their results to yield AE+BG. A total of eight times option 1 operations, i.e., 8*4=32 pipe-cycles, will yield a desired product XY. Such partition can be used recursively. To compute the same product of 16-b items, two levels of partition and option 2, instead of option 1, can be used with 8*2*8=128 pipeline cycles.

The operations of (4×4) matrices with various item precision are particularly important for graphics applications. The matrix items may include 8-b, 16-b and occasionally 32-b or even 64-b data for special needs. Efficient use applications of matrix multipliers of (s, m)=(32, 8) and (s, m)=(64, 8) are illustrated below. First, with the (s, m)=(32, 8) matrix multiplying processor shown in FIG. 7, the product of X(4×4) and Y(4×4) with 8-b items in every 4 pipeline cycles (FIG. 8b) and the product of two 32-b numbers in every one cycle (FIG. 10) can be computed. The product of X(2×2) and Y(2×2) with 16-b items in every two cycles (FIG. 9) can also be computed. Using the matrix partitioning technique shown in FIG. 11, the product of X(4×4) and Y(4×4) with 16-b items in every 8*2=16 cycles can be computed, since in order to generate a quarter block of the product matrix only two multiplications of X(2×2)*Y(2×2) with 16-b items and accumulation of their sums are required. The advantage of using a (32, 8) matrix multiplying processor is that it is simple and capable of dealing with a majority of operations for the above applications. The disadvantages are that such a matrix multiplying processor is unable to deal with data with precision higher than 32-b.

FIG. 12 shows a complete (s, m)=(64, 8) matrix multiplier created by adding a duplication net and a distribution net to the matrix multiplier of FIG. 5c. Similar to a (32, 8) matrix multiplier of FIG. 7, it includes the input duplication net, the distribution net and the (64, 8)′ module illustrated in FIG. 5c.

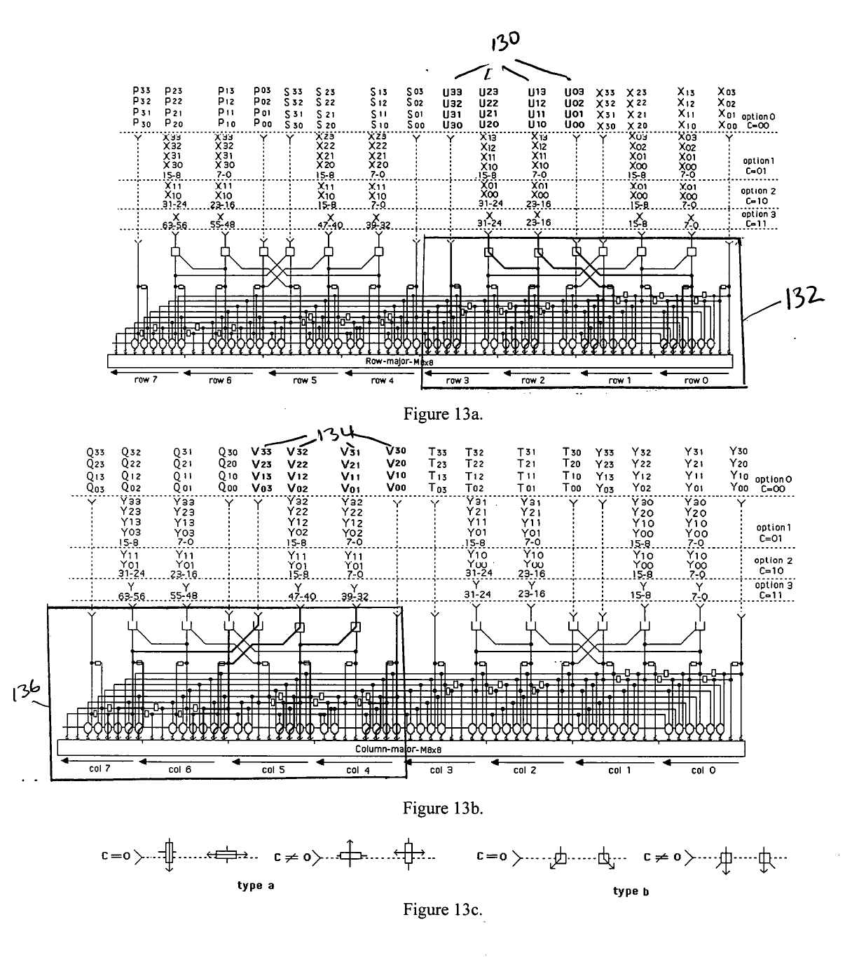

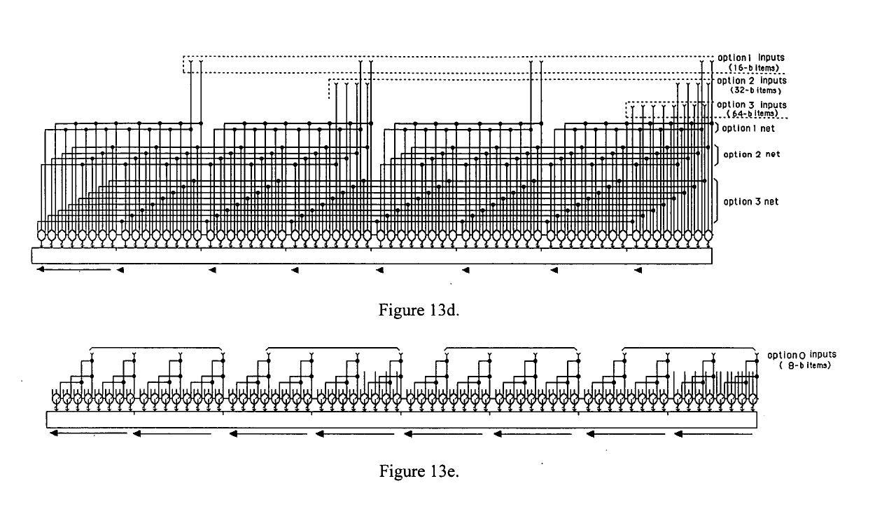

FIGS. 13a-13e show the reconfigurable duplication network of the matrix multiplier (64, 8). FIGS. 13a and 13b depict the input duplication network specific to the (64, 8) matrix multiplying processor, where each net has four input options corresponding to the four values of 2-bit control C. The matrix multiplier is reconfigurable for:
(C=0) parallel multiplications of four matrix pairs designated as X(4×4)*Y(4×4)=Z(4×4), U(4×4)*V(4×4)=W(4×4), P(4×4)*Q(4×4)=O(4×4), and S(4×4)T(4×4)=R(4×4), of 8-bit items;
(C=1) multiplication of two matrices X(4×4) and Y(4×4) of 16-bit items;
(C=2) multiplication of two matrices X(4×4) and Y(4×4) of 32-bit items; and
(C=3) multiplication of two 64-b numbers, X and Y. All four options can be controlled by a 2-b signal C=CbCa, since C1=Ca or Cb, C2=Cb, C3=Ca and Cb.

The operations with C=1, 2 and 3 are the same as those for the (32, 8) matrix multiplier, except the input/output size can now be four times that for the (32, 8) matrix multiplying processor. It is noted that the (64, 8) matrix multiplying processor has about four identical components working in parallel, each equivalent to a single (32, 8) matrix multiplying processor. Also putting four blocks of (32, 8) in parallel is not able to provide multiplication of two 64-b numbers. The operation with C=0 requires an additional reconfigurable duplication unit to support an efficient operation and unified control.

The conceptual view of an input duplication net for options 1, 2, and 3 is shown in FIG. 13d, which can be seen as size-enlarged duplication switches of FIG. 6b. The conceptual view of the distribution network for option 0 is shown in FIG. 13e. It is straightforward to verify that the unification and optimization of these two duplication networks will lead to the simplification shown in FIG. 13a, where the left duplication network 132 and the four inputs 130 of matrix U of option 0 are highlighted, and FIG. 13b, where the right duplication network 136 and the four inputs 134 of matrix V of option 0 are highlighted, assuming the 2-b control reconfiguration switch of FIG. 13c illustrating the additional two types of reconfigurable switches and their two states, is adopted.

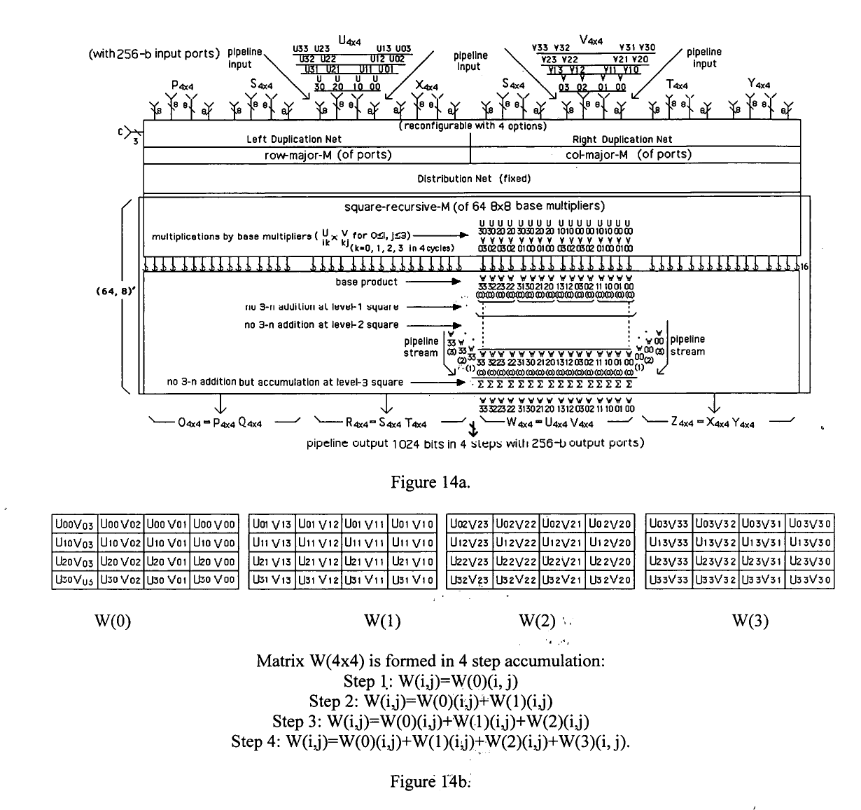

FIGS. 14a and 14b illustrate the complete views of option 0 of the matrix multiplier (64, 8). FIG. 14a illustrates the pipelined data flows and accumulations for the operation option 0, with four pairs of 4×4 (8-bit) matrix multiplications in parallel when C=00 (with W=UV). FIG. 14b illustrates the conceptual view of the computation of W=U(4×4)*V(4×4) in every 4 cycles according to Equation E (in 4 pipeline steps).

The Implementation Circuits

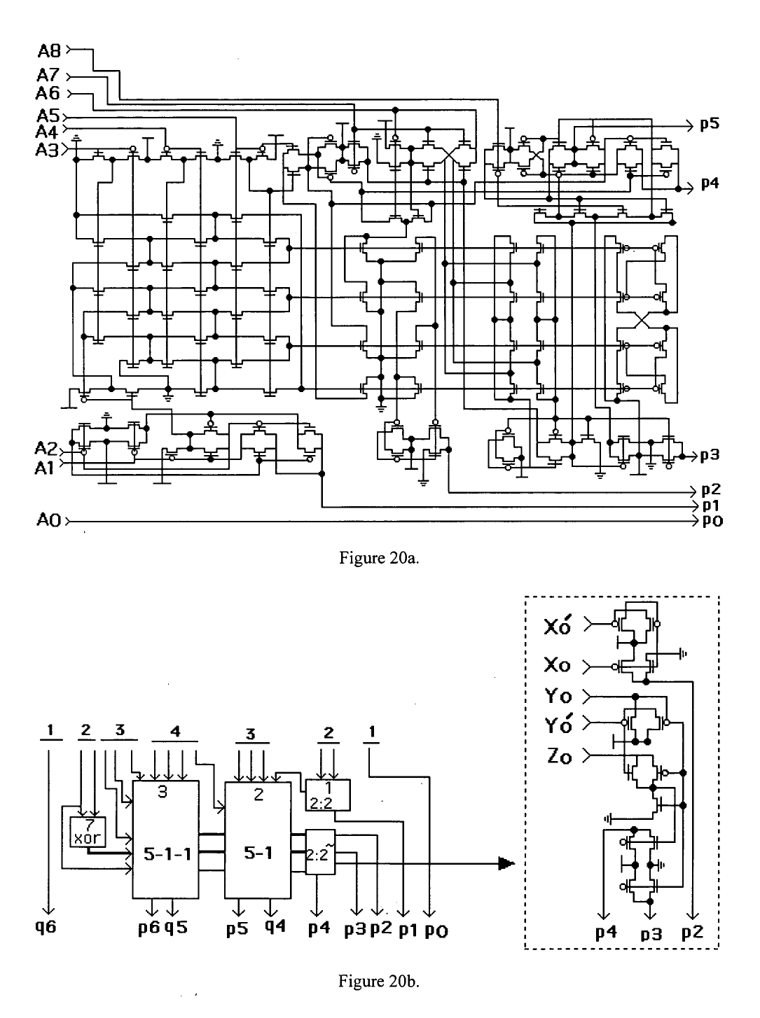

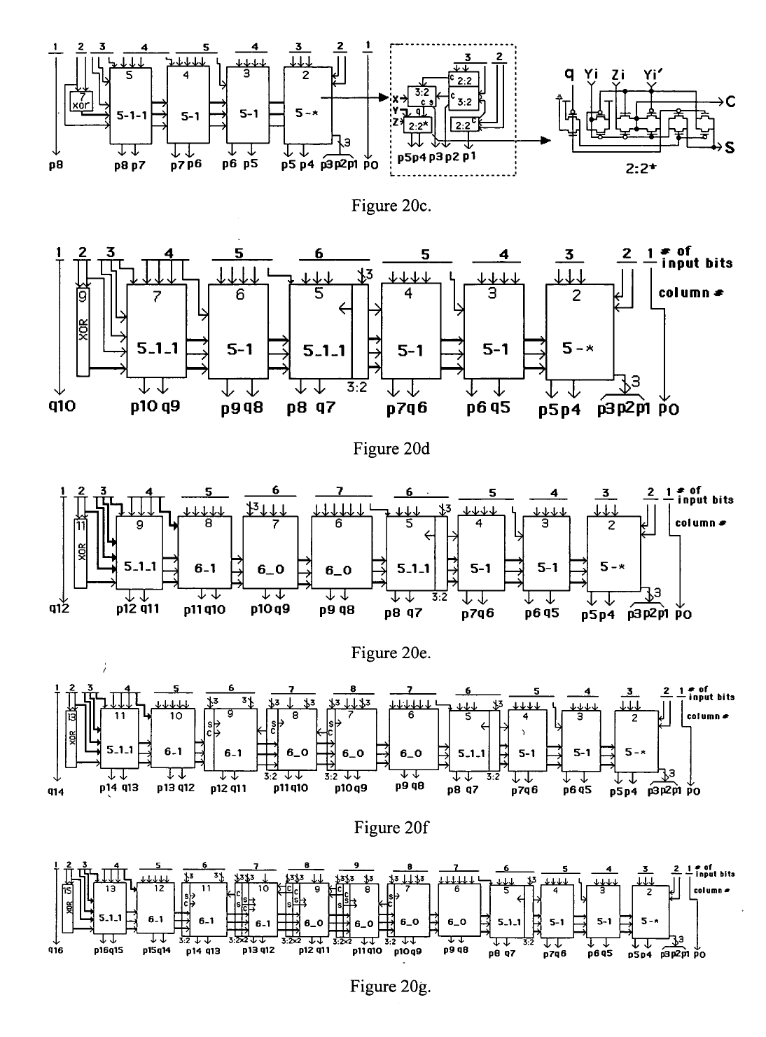

Since the large amount of 8×8 base multipliers requires a significant percentage of the matrix multiplier area, a novel design of highly regular, compact, low power small multiplier circuits for the implementation of the 8×8-b base multiplier of the present invention is presented below. The 8×8 multiplier, called a borrow parallel multiplier, which is an array of borrow parallel counters is described in R. Lin and R. Alonzo, “An Extra-Regular, Compact, Low-Power Multiplier Design Using Triple-Expansion Schemes And Borrow Parallel Counter Circuits”, Proc. Of Workshop On Complexity Reduced Design (Isca), Held In Conjunction With The 30th Intl. Symposium On Computer Architectures, San Diego, Calif., June 2003, the contents of which are incorporated herein by reference, (hereinafter “RL4”); and in RL0, RL1, and RL2. The 8×8 borrow parallel multiplier can be laid out in an area of 33 mm×167 mm (with 0.18 mm technology, 3 metal layers; see FIG. 20) which is competitive with the best known complementary metal oxide semiconductor (CMOS) 8×8 multiplier. The 8×8 borrow parallel multiplier also possesses several unique properties in CMOS digital designs, which are described below.

The borrow parallel counters possess the following advantages:
use 1-hot out of four lines signal encoding;
merge type-conversions and additions through using an embedded full adder circuit; and

utilize borrow bits, i.e., input bits weighted 2, which make it possible for a small multiplier, such as 8×8-b multiplier, to be organized in a single array of almost identical parallel counters for a compact layout.

TABLE 1

| $R = \begin{matrix}\begin{matrix}\begin{matrix}r 3 \\ r 2\end{matrix} \\ r 1\end{matrix} \\ r 0\end{matrix}$ | $\begin{matrix}\begin{matrix}\begin{matrix}0 \to \\ 0 \to \end{matrix} \\ 0 \to \end{matrix} \\ 1 \to \end{matrix}$ | $\begin{matrix}\begin{matrix}\begin{matrix}0 \to \\ 0 \to \end{matrix} \\ 1 \to \end{matrix} \\ 0 \to \end{matrix}$ | $\begin{matrix}\begin{matrix}\begin{matrix}0 \to \\ 1 \to \end{matrix} \\ 0 \to \end{matrix} \\ 0 \to \end{matrix}$ | $\begin{matrix}\begin{matrix}\begin{matrix}1 \to \\ 0 \to \end{matrix} \\ 0 \to \end{matrix} \\ 0 \to \end{matrix}$ |
|---|---|---|---|---|
| decimal value of R | 0 | 1 | 2 | 3 |
| binary value of R = s1s0 | 00 | 01 | 10 | 11 |
| binary value of s0 (encoded by R) | 0 | 1 | 0 | 1 |
| binary value of s1 (encoded by R) | 0 | 0 | 1 | 1 |

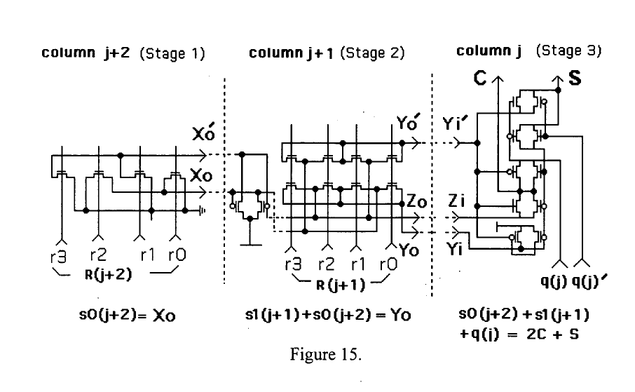

Table 1 shows the “4-bit 1-hot” (4-b 1-hot) encoded signals and their value interpretations. The unique bit position determines the value of a 4-b 1-hot signal. FIG. 15 shows a full adder circuit, which adds two bits, encoded in 4-b 1-hot form, s0 and s1, and a binary bit q without a type conversion. Actually, s0, s1, and q are signals in three adjacent columns for an arithmetic operation, with s0 in the highest weighted column. The adder circuit is competitive as compared with conventional full adders in terms of speed, area, and power dissipation. It requires 24 transistors if no output buffers are needed; among these transistors are at least 6 transistors that have no switching activity during any logic stage. There is no explicit data conversion and the 2-b output (C, S) is in binary form. The circuit has a complementary pass transistor logic (CPL), NMOS transistors and small pMOS for voltage level restoration binary signal, as described in J. H. Pasternak, A. S. Shubat, and C. A. T. Salama, “CMOS Differential Pass-Transistor Logic Design”, IEEE JSSC, SC-22, 1987. PP. 216-222; and C. F. Law, S. S. Rofail, and K. S. Yeo, “A Low-Power 16×16-b Parallel Multiplier Utilizing Pass-Transistor Logic”, IEEE J. of Solid-State Circuits, vol. 34, no. 10, pp. 1395-1399, October 1999, and uses a 2-b z-state signal, i.e., with a zero bit and a hi-z representing a double-rail, the contents of which are incorporated herein by reference, (see RL3 and RL2).

The Borrow Parallel 5_1 and 5_1_1 Counters and Their Extension, Borrow Parallel 6_0 and 6_1 Counters

The present invention also sets forth a description of the borrow parallel circuits including new proof of the borrow parallel counter 5_1 and 5_1_1 circuits and their extension borrow parallel counter circuits 6_0 and 6_1, as well as an alternative library of small multipliers. In addition to the implementation of the proposed matrix multipliers, the borrow parallel circuits can be used for various applications including design of whole spectrum of large multipliers, e.g., up to 81-bit, (see RL0). The inventive borrow parallel counters utilizing the 4-b 1-hot signals and their additions are presented herein below. These counters are termed borrow (parallel) counters because one or more of the bits being counted by such counters have a weight of 2 instead of 1, such bits are called “borrowed” as they are borrowed from the left neighboring columns.

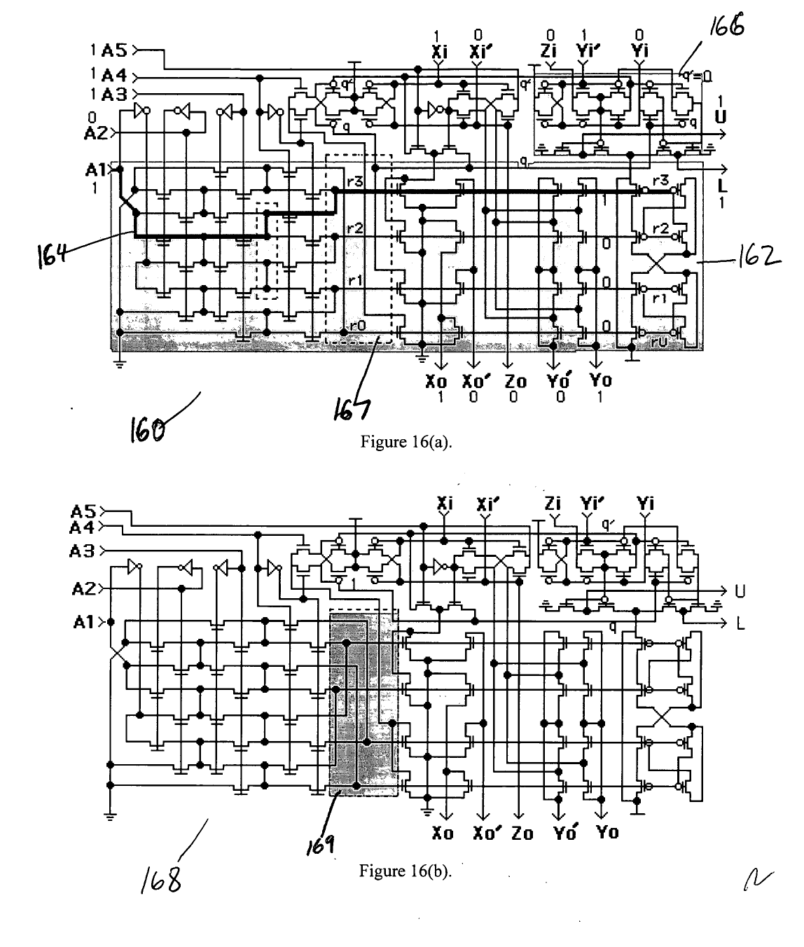

FIGS. 16a and 16b illustrate two extra-compact, low-power, high-speed CMOS circuits, serving as building blocks for parallel arithmetic designs. FIG. 16a shows a borrow parallel counter 5_1 circuit 160, the large shaded rectangular area 162 shows the regular distribution of cells with the 4-b 1-hot features, i.e., four parallel data paths having only one path in logic high, for example the input bold line 164; the offset input A5 shows a “borrow bit”, a bit having a value of 2 instead of 1. The small shaded area 166 shows a simplified adder. FIG. 16b shows borrow parallel counter 5_1_1 circuit 168. This circuit 168 is similar to the borrow parallel counter 5_1 circuit 160 (FIG. 16a), except for the dotted area 167 (FIG. 16a), which is replaced by dotted area 169. There are two borrow bits in the circuit 168 they are inputs A4 and A5.

Each of the borrow parallel counter circuits 5_1 and 5_1_1 has 5 inputs, A1 to A5, two outputs U and L, and three pairs of in-stage input/output bits, X, Y, Z, where the weighted sum of all outputs equals the weighted sum of all inputs. Input bit A5 (or A4), weighted 2, is usually borrowed from the higher weighted neighboring columns and its input arrow in the circuit is offset.

In addition to utilizing 4-b 1-hot signal encoding and borrow bits, the borrow parallel counter circuits provide an embedded full adder, adding non-binary (4-b, 1-hot) and binary signals without decoding. A pass-transistor circuit illustrated in FIG. 16a, possesses the following unique features:
1. Excellent distribution of transistors, good ratio of negative and positive channel metal oxide semiconductor (nMOS/pMOS) cells, and the embedded addition result in highly compact layout.
2. The majority of the transistors are gated by, or used to pass, 4-b 1-hot signals, which leads to the reduction of both switching activities and the flow of hot signals by about a half (see RL2). This is very significant for low-power designs.
3. Having the borrow bits, each weighted 2 or more, makes it possible to form small multipliers, ranging from 3 to 9 bits, in a single array of counters structure, shown in FIGS. 20a to 20g. Such structure includes many useful properties, including equal-height, perfect rectangular shape, compactness, and requiring simple CMOS formation process to achieve inexpensive manufacturing and size reduction, as well as equal-delay, low-power, high-speed to achieve less expensive and more productive use.
   The circuit can also be used as an alternative building block, replacing traditional half-adder 2:2, full-adder 3:2, and 4:2 counters for different arithmetic processor designs.

The borrow parallel counter 5_1 circuit implements the five arithmetic-logic equations shown below:
A1+A2+A3+A4+2A5=4q+2c+s (or=qcs in binary form) (M1)
Xo=s; (B1)
Yo=Xi XOR c; (B2)
Zo=Xi′ (B3)
SUM=2U+L=Yi+2Yi′ Zi′+q; (M2)

The explanation of how the circuit illustrated in FIG. 16a or the given equation system works bit-reductions, and its benefits are discussed below. It can be easily verified that the 4-b 1-hot encoding sub-circuit, the left half of the large shaded area of FIG. 16a, encodes A1, A2, A3, and A4, but not A5, for R=2c0+s0 and q0, where R is a remainder and q0 is a quotient, so that
A1+A2+A3+A4=4q0+R.
Since A1+A2+A3+A4+2A5=4q0+2c0+s0+2A5,
let 4q0+2(c0+A5)+s0=4q+2c+s,
thus s=s0 (D1)
4q0+2(c0+A5)=4q+2c=>c=c0 XOR A5 (D2)
q=q0 or c0A5 (D3)
The 4-b 1-hot encoding scheme shown in Table 1 results in:
1. r0 or r2=1<=>s0=0 or r1 or r3=1<=>s0=1; and
2. r0 or r1=1<=>c0=0 or r2 or r3=1<=>c0=1 (D4)

From Equation D4 it is verified that
Xo=s0 and Yo=(Xi XOR A5)XOR c0=Xi XOR(c0 XOR A5)
Equation D1 provides:
(B1): Xo=s;
   Equation D2 provides:
(B2): Yo=Xi XOR c; and
(B3): Zo=Xi′ is a fact.
   Note that Xo, Yo will be restored by the pMOS pairs in the counter connected to them.
   Since R=A1+A2+A3+A4=4q0+R and R<=4<=>if R=0 (i.e., r0=1)=>q0=A4, and R>0=>q0=0;
   From Equations D3 and D4 it follows that:
   r0=1=>q=A4 (since q0=A4, c0=0);
   r1=1=>q=0 (since q0=0, c0=0);
   r2 or r3=1=>q=A5 (since q0=0, c0=1).

This can also be verified from the circuit shown in FIG. 16a, thus 4 is implemented correctly. It can also be verified, e.g., by a truth table, that the simplified adder circuit 166, of the smaller shaded area of FIG. 16a, correctly implements arithmetic Equation M2. So borrow parallel counter 5_1 circuit implements the equation system. It is easy to see that borrow parallel counter 5_1_1 circuit, shown in FIG. 16b, implements the same system except that in Equation M1, the coefficient of A4 should be 2 instead of 1.

The above provided proof is also achieved by an exhaustive verification program for all possible inputs and outputs. For example, inputs shown in FIG. 16a, the following is derived from Equations:
A1+A2+A3+A4+2A5=5=>q=1, c=0, s=1 and
Xo=1, Yo=1, Zo=0, SUM=3, U=1, L=1.

The circuit of FIG. 16a implements r3=1, q′=0 and then restores q to 1;
Xo′=0, and Xo to 1;
Zo=Xi′=0;
Yo=A5=1, Yo′=A5′=0 (note: Yo and Xo are restored by the pMOS pairs in the adjacent counter); and
U=NOT Yi=1, L=NOT Zi=1.

Th above verifies that the circuit of FIG. 16a works correctly for the inputs.

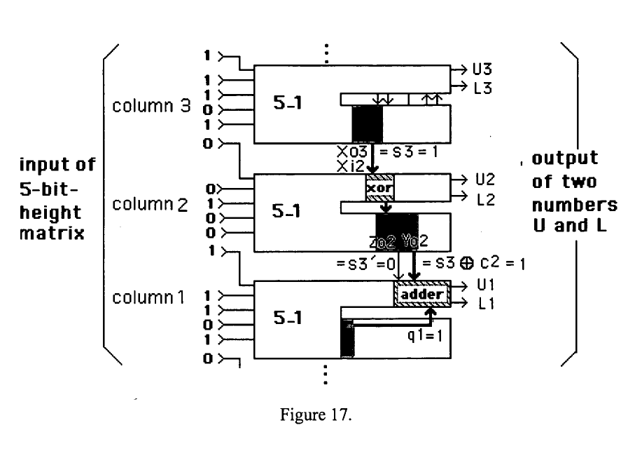

To explain how the circuit of FIG. 16a (or the equation system) works for applications is to illustrate its actual functions in a typical application environment, i.e., using a single array of borrow parallel counter 5_1 circuits, as shown in FIG. 17, to reduce the input of a 5-bit-height bit-matrix to two number output.

With reference to FIG. 17, assuming there are n columns having weights of 0 to n-1, respectively, (n is sufficiently large to exclude a special cases in which two end counters are used) each column accepts 5 inputs bits generally denoted as A1 to A4 weighted 1 and A5 weighted 2, the weights are relative to their columns. The in-stage outputs, Xo, Yo, Zo of column i+1 are correspondingly connected to the in-stage inputs, Xi, Yi, Zi of column i. only three contiguous columns need to be shown because the process for other columns is identical. Columns are denoted i+1, i+2, and i+3, for simplicity i will be omitted and columns will be called 1 to 3 as shown in FIG. 17.

Let s, c, q, Xi, Xo, Yi, Yo, Zi, Zo, L, U and SUM of the counter in column k be sk, ck, qk, Xik, Xok, Yik, Yok, Zik, Zok, Uk, Lk and SUM k (for k=1, 2, 3) respectively, the outputs 6f the adder of column 1, i.e., U1 and L1 will be compute to show
2U1+L1=s3+c2+q1.

From Equation B1 it follows that Xo3=s3;
From Equation B2:
   Yo2=Xi2 XOR c2=Xo3 XOR c2=>Yo2=s3 XOR c2 (D5)
   From Equation M2:
   SUM1=2U1+L1=Yi1+2Yi1′Zi1′+q1 (D6)

It can be verified that if conditions Yi=s3 XOR c2 and Zi=s3′ are true, then Yi+2Yi′Zi′ is equivalent to s3+c2.

The verification is provided below by the truth table shown in Table 2.

TABLE 2

| s3, c2 | Yi = s3 XOR c2 | Zi = s3′ | Yi + 2Y′Zi′ | s3 + c2 |
|---|---|---|---|---|
| 0 0 | 0 | 1 | 0 | 0 |
| 0 1 | 1 | 1 | 1 | 1 |
| 1 0 | 1 | 0 | 1 | 1 |
| 1 1 | 0 | 0 | 2 | 2 |

Equation D5 provides the following conditions: Yi1=Yo2=s3 XOR c2, Equations B3 and B1: Zi1=Zo2=Xi2′=Xo3′=s3′, therefore there exists the equivalence of Yi1+2Yi1′Zi1′ and s3+c2.

Finally Equation D6 provides:
SUM1=2U1+L1=s3+c2+q1 (D7)

Using the above provided proof, an array of borrow parallel counter 5_1 or/and 5_1_1 circuits can be viewed as parallel counters for reducing 5-bit-height input matrix into a set of s, c, and q bits, which set is further reduced in accordance with Equation D7 into two numbers Ui and Li.

Each borrow parallel counter 5_1 or 5_1_1 circuit can also be viewed as an effective counter for reducing 5 input bits having one or more borrow bits into two output bits. The addition of s3 and c2, which is embedded in the 4-b 1-hot signal form, by sub-circuits as shown in the shaded area of columns 3 and 2 in FIG. 17. The result is then added to q by the simplified adder of Column 1.

The borrow parallel counter 5_1 and 5_1_1 circuit can be represented by a single arithmetic equation shown below, where the sum of all weighted inputs equals the sum of all weighted outputs:

For borrow parallel counter 5_1 circuit:
A1+A2+A3+A4+2A5+2Xi+4(Yi+2Yi′Zi′)=Xo+2Yo+4Yo′Zo′+4L+8U
For borrow parallel counter 5_1_1 circuit:
A1+A2+A3+2A4+2A5+2Xi+4(Yi+2Yi′Zi′)=Xo+2Yo+4Yo′Zo′+4L+8U

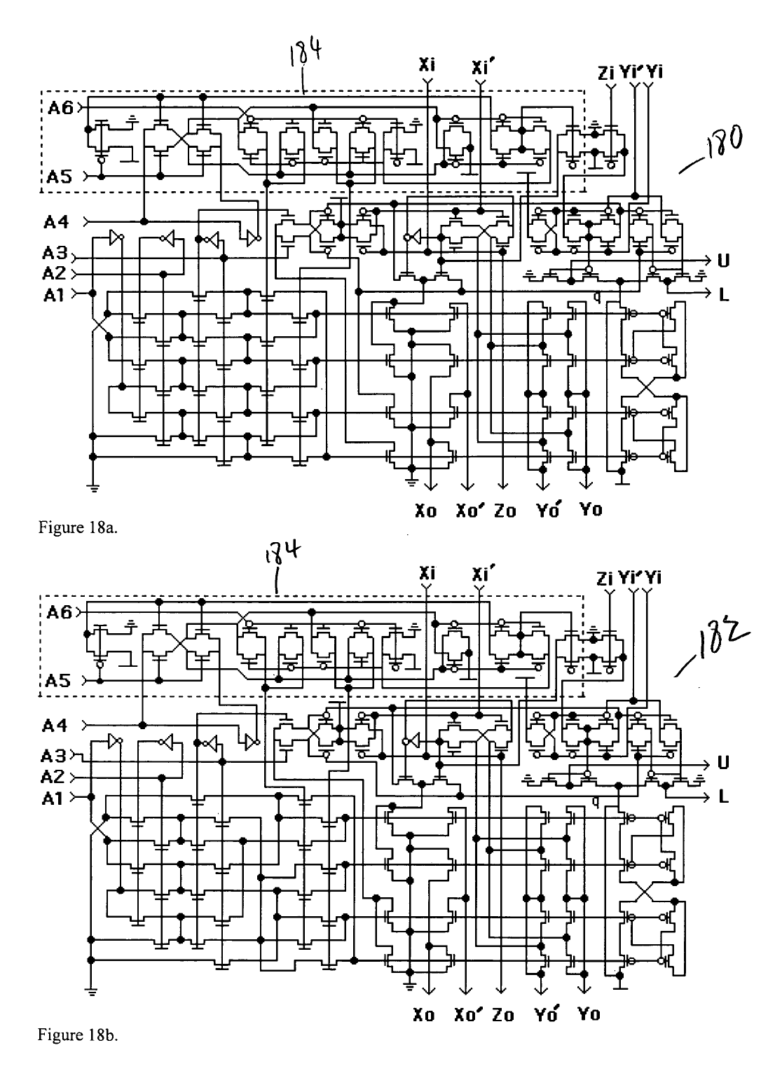

FIGS. 18a and 18b illustrate additional 4-b 1-hot borrow parallel counter variants called borrow parallel counter 6_0 and 6_1 circuits 180 and 182, respectively. Each of the circuits 180 and 182 includes 6 inputs A1 to A6. All 6 input bits of the borrow parallel counter 6_0 circuit 180 are weighted 1. For the borrow parallel counter 6_1 circuits 182, the input bit A3 is weighted 2. The borrow parallel counter 6_0 or 6_1 circuit 180 and 182 are constructed using the borrow parallel counter 5_1 or 5_1_1 circuits 160 and 168 (FIG. 16). The new borrow parallel counter circuits add a 3:2 novel shift switch parallel counter circuit 184, shown in the dotted box. The 3:2 shift switch parallel counter was fully described in a co-pending U.S. patent application Ser. No. 09/812,030 titled “A Family Of High Performance Multipliers And Matrix Multipliers” contents of which are incorporated herewith by reference.

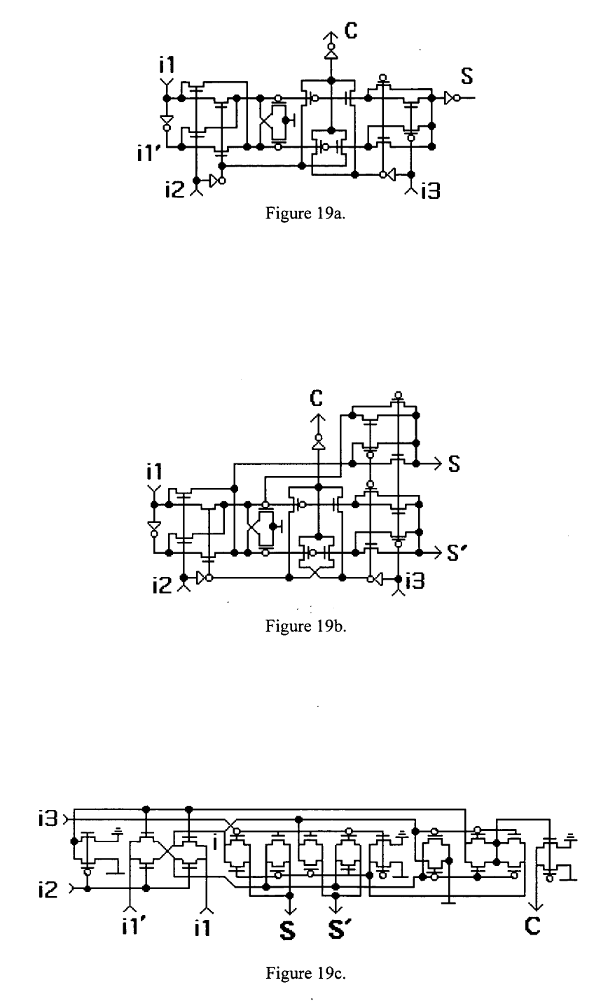

FIG. 19a shows an existing 3:2 shift switch parallel counter (see RL6). FIG. 19b illustrates an improved 3:2 shift switch parallel counter. The improved counter of FIG. 19b creates a double-rail output S without increasing the total number of transistors required for shift switch parallel counters, such as that of FIG. 19a. The savings are achieved through deleting both the output buffer for S and the inverter for generating S complement, which significantly improves the speed of the circuit and makes it possible for the borrow parallel counter 6_0 and 6_1 circuits to have a delay similar to that of a borrow parallel counter 5_1 or 5_1_1 circuit. FIG. 19c shows the 3:2 shift switch parallel counter presented in the form used as the circuit 184 of the borrow parallel counter 6_0 and 6_1 circuits 180 and 182 of FIGS. 18a and 18b.

The Alternative Library of Small Borrow Parallel Multipliers

One of the benefits of using the above described four 4-b 1-hot parallel counter circuits is the formation of a library of small multipliers ranging from 3 to 9 bits in a single array of counters structure. FIGS. 20a to 20g represent a library of seven small multipliers ranging from 3-bit to 9-bit respectively, the small multipliers possess many attractive properties, including equal-height, equal-delay, low-power consumption, high-speed performance, perfect rectangular shape. All the library circuits are very compact and requiring simple CMOS process to manufacture. The library circuits are used as building blocks to design larger multipliers.

Conventional binary counter based parallel multiplier circuits, including 8×8-b multiplier, are highly irregular in shape because a partial product bit matrix has a triangular shape. It is not efficient to re-arrange the bit matrix for bit reduction using small-size binary parallel counters. The layout cost in dealing with the irregularity can be significant. One of the major benefits of the library of small multipliers, is its ability to turn irregular small multiplication units into regular circuit blocks, thereby greatly reducing local complexity of large circuits.

As illustrated in FIGS. 20a to 20g, each n×n-b small parallel multiplier, where n is an integer between 3 and 9, receives two n-bit input numbers and produces two output numbers. Partial product generators and final adders used in these circuits are not included in FIGS. 20. The small parallel multipliers of FIGS. 20 are made up of array of almost identical counters. This construction is made possible due to the use of borrow bits, which make it possible to rearrange the inputs to each column to be balanced for each column.

The inventive library of small multipliers improves the library based on two borrow parallel counter 5_1 and 5_1_1 circuits (see RL0). Each multiplier in the library of this invention is constructed the same way by a single array of borrow parallel counters plus a few 3:2 and/or 2:2 shift switch parallel counter. The library of the present invention includes four borrow parallel counter 5_1, 5_1_1, 6_0 and 6_1 circuits. They all have about the same small height as that of a single borrow parallel counter 5_1 circuit, plus the height of an input net. Similarly, these borrow parallel counter have about the same delay and display a very compact layout, high speed performance, and low-power utilization features.

The 8×8 Small Borrow Parallel Multiplier

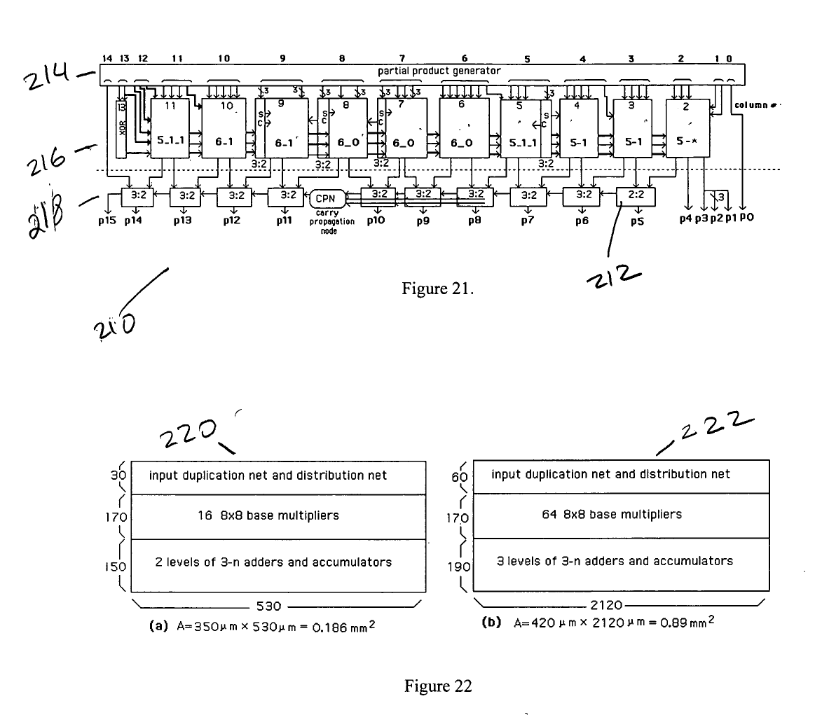

FIG. 21 shows an exemplary implementation of the reconfigurable matrix multiplier of the present invention using the small multiplier library components, i.e., the 8×8 small borrow parallel multiplier 210. It is similar to the small multipliers shown in FIG. 20f, it includes an array of ten borrow parallel counter 5_1, 5_1_1, 6_0, and 6_1 circuits 216 numbered 2 to 11 in the right to left direction, plus a number of supporting 3:2 and 2:2 shift switch parallel counter 218. The numbers residing inside the symbol boxes indicate the column numbers. The 2:2 shift switch parallel counter, identified by numeral 212, is a small circuit used for restoring non-full swing inputs and generating a carry bit p4. The multiplier 210 includes three parts:
1. the top rectangular box 214 representing the partial product generator;
2. the middle part 216, shown above the dotted line and below the top rectangle representing a virtual multiplier or the partial product reduction network, i.e., the array of borrow parallel counters and its supporting 3:2/2:2 shift switch parallel counters, which reduces the partial products generated by the generator into two numbers; and

3. the bottom part 218, shown below the dotted line, representing a fast and simple one stage carry look-ahead adder with a carry propagate node denoted by CPN.

TABLE 3

| | | | | | 0.18 μm 1.8 V | |
|---|---|---|---|---|---|---|
| | | | | | technology | |
| circuit | | | area | $\frac{nMOS}{pMOS}$ | delay (ns) | $\begin{matrix}power \\ ( \frac{μW}{MHz} )\end{matrix}$ |
| counter | borrow | 5_1 | 190 | 2.7 | 0.6 | 0.07 |
| | parallel | 5_1_1 | 190 | 2.7 | 0.6 | 0.07 |
| | binary | (2, 2) | 50.7 | 1.1 | 0.1 | 0.02 |
| | counters | (3, 2) | 84.0 | 1.8 | 0.16 | 0.036 |
| | [6] | (4, 2) | 165.5 | 1.5 | 0.3 | 0.045 |
| multi- | borrow | 8 × 8 | 5511 | 2.4 | 1.2 | 1.23 |
| plier | parallel | | (1) | | | |
| | binary | referto | 6828 | 1.4 | 1.5 | 2.26 |
| | (3, 2) − (4, 2) | [9, 13, 15] | (1.24) | | | |
| | based | | | | | |

Table 3 shows the summary and comparison of the parallel counters and 8×8 multipliers. The layouts of the borrow parallel counter 5_1, 5_1_1 circuits and the 8×8 multiplier using 180 μm CMOS technology and 3 metal layers with areas of 12.87×16.0 μm² and 26.5×85.5 μm², respectively, have been produced (see RL4). The 8×8 multiplier illustrated in FIG. 21 fits perfectly for the inventive reconfigurable matrix multipliers. That is because the illustrated 8×8 multiplier's regularity, compactness, and a rectangular shape with a very narrow width (ratio of length to width is 167/33=5.0), make it possible to have a large number of base multipliers line up in one side. The use of multipliers on one side of a circuit is preferred by the inventive reconfiguration scheme.

The preliminary results of current studies focusing on optimal layouts of duplication-distribution networks and the block-1, block-2, and block-3 modules, have shown that all these components may be laid out in matching the total width defined by the base multiplier array 220 for 530 μm and the base multiplier array 222 for 2120 μm as shown in FIG. 22. The heights, including pipeline latches, of the (32, 8) and (64, 8) matrix multipliers are estimated to be 350 μm for the base multiplier array 220, comprising 30 μm for input duplication and distribution net, 170 μm for (16 8×8) base multipliers, and 150 μm for 2 levels of 3-n adders and accumulators, and 420 μm for the base multiplier array 222, comprising 60 μm for input duplication and distribution net, 170 μm for (64 8×8) base multipliers, and 190 μm for 3 levels of 3-n adders and accumulators, respectively. The overall pipelined matrix multipliers can be laid out (4-metal-layer) using areas of 350×530=0.186 mm and 420×2120=0.89 mm² as shown in FIG. 22.

Since there is no reported data available for a comparable architecture, a comparison can be made with a 54×54 floating point Booth multiplier, recently reported in N. Itoh, Y. Naemura, H. Makino, Y. Nakase, T. Yushihara, Y. Horiba, “A 600 MHz, 54×54-bit Multiplier With Rectangular-Styled Wallace Tree”, IEEE JSSCs, Vol. 35, No. 2, February 2001, (hereinafter “Itoh”) and R. Montoye, W. Belluomini, H. Ngo, C. McDowell, J. SaWada, T. Nguyen, B. Veraa, J. Wagoner, M. Lee, “A Double Precision Floating Point Multiplier”. Proc. of 2003 IEEE ISSCC, February, 2003 (hereinafter “Montoye”). The Booth multiplier has the minimum area. The comparison is achieved by first scaling up Booth floating point multipliers to size 64, then comparing it with the inventive (64, 8) matrix multiplier. The multiplier of Itoh, fabricated in the same 0.18 mm technology, requires an area of 0.98 mm², while the multiplier of Montoye fabricated in the 0.13 mm technology, requires an area 0.155 mm², which will be 0.49 mm when scaled for 0.18 mm technology (see Montoye).

Based on these data, the inventive reconfigurable matrix multiplier architecture with borrow parallel counter circuits has shown itself to be competitive, particularly when the multiple provided functionalities are considered. A summary and simplified comparison of these three matrix multiplying processors are given in Table 4.

TABLE 4

| | | | area relative value | | | pipeline | |
|---|---|---|---|---|---|---|---|
| | area | | (scaled for technology | | pipeline | frequency | |
| processor | (mm²) | technology | and input size) | operation | throughput | (GHz) | power |
| reconfigurable | 0.89 | 0.18 μm | 1.29 | multiplication (64 × 64-b) | 1 | 0.85 | NA* |
| matrix multiplier (64, 8) | | 1.8 V | | M_{4×4} × N_{4×4} (32-b) | $\frac{1}{16}$ | | |
| this work | | | | M_{4×4} × N_{4×4} (16-b) | $\frac{1}{4}$ | | |
| | | | | 4 pairs of M_{4×4} × N_{4×4} (8-b) | $1 = 4 * \frac{1}{4}$ | | |
| rectangular-styled | 0.98 | 0.18 μm | 2 | multiplication (54 × 54-b) | 1 | 0.6 | NA |
| Wallace tree | | 1.8 V | | | | | |
| multiplier [5] | | | | | | | |
| limited switch | 0.15 | 0.13 μm | 1 | multiplication (53 × 54-b) | 1 | 2 | 522 |
| dynamic logic | | 1.2 V | | | | | mW |
| multiplier [6] | | | | | | | |

The inventive matrix multiplying processor can be run-time reconfigured to trade bitwidth for a matrix size for general multiplications of matrices. Specifically, the inventive matrix multiplying processor can be efficiently reconfigured to compute the product of matrices X(4×4) and Y(4×4) for graphics and image processing applications. The hardware comparable with one 64×64 bit high precision multiplier with minimal additional reconfiguration components can provide four computation options, which significantly reduces the total amount of hardware needed by existing computation systems.

The proposed inventive architecture minimizes the common irregularity that occurs in existing designs, and simplifies the overall logic scheme and circuit structures. The superiority of the architecture is achieved, particularly, through the use of CMOS borrow parallel counter circuits and small multipliers, which utilize 4-b, 1-hot integer encoding (valued 0 to 3), borrow bits, and a single counter array structure for multiplying small integers, achieving an extra compact layout and lower switching activity for low-power design.

The small 8×8 multiplier array based matrix multiplying processors also possess several unique features in self-testability and high design quality (see RL5). The architecture may also be extended as a unified arithmetic processor to provide inner product computation as well (see RL1).

While the invention has been shown and described with reference to certain preferred embodiments thereof, it will be understood by those skilled in the art that various changes in form and details may be made therein without departing from the spirit and scope of the invention as defined by the appended claims.

1. A matrix multiplier circuit receiving items having bitwidth ranging from 4 to 64 bits in a plurality of pipeline cycles, the circuit comprising:
a duplicating circuit for duplicating and distributing said received items;
a plurality of matrix multipliers for generating a product of at least two matrices;
at least one adder for adding partial products to create a plurality of results;
a plurality of accumulators for accumulating the plurality of results; and
a reconfiguration mechanism including reconfiguration switches, wherein said switches are set to states enabling said circuit to perform an operation selected from said adding and accumulating.

2. The matrix multiplier circuit of claim 1, wherein the at least two matrices are X(p×r) and Y(r×q), where p, q, r are integers describing matrix dimensions.

3. The matrix multiplier circuit of claim 1, wherein the plurality of accumulators is implemented using borrow parallel counter circuitry utilizing 1-hot out of four line signal encoding and borrow bits.

4. The matrix multiplier circuit of claim 3, wherein said borrow parallel counter circuitry merges conversion and arithmetic operations into an embedded full adder circuit.

5. The matrix multiplier circuit of claim 4, wherein a plurality of transistors being gated by 4-b 1-hot signals is provided, which results in a significant reduction in switching activity and hot data paths.

6. The matrix multiplier circuit of claim 5, wherein an area used for the matrix multiplier circuit is similar in size to that used for a single 64×64-b matrix multiplier circuit constructed of very large-scale integrated (VLSI) circuits.

7. The matrix multiplier circuit of claim 5, wherein an area on said circuit taken by said plurality of matrix multipliers is 0.18 mm and an area taken by said parallel counter circuitry is 0.25 mm.

8. The matrix multiplier circuit of claim 1, wherein said circuit is directly reconfigured to produce a product of two matrices having sizes selected from at least one of:
(1×1) when 64 bits of input are provided in every pipeline cycle,
(2×2) when 32 bits of input are provided in every 2 pipeline cycles,
(4×4) when 16 bits of input are provided in every 4 pipeline cycles,
(8×8) when 8 bits of input are provided in every 8 pipeline cycles, and
(16×16) when 4 bits of input are provided in every 16 pipeline cycles,

9. The matrix multiplier circuit of claim 8, wherein the circuit further being directly reconfigured to produce a product of selected from one of
four 16-item square matrix pairs of 8-bit data in every 4 pipeline cycles,
(4×4) when 16 bits of input are provided in every 4 pipeline cycles,
(4×4) when 32 bits of input are provided in every 16 pipeline cycles, and
a product of two 64-b numbers in every pipeline cycles.

10. The matrix multiplier circuit of claim 9, wherein the reconfiguration mechanism performs dynamically and in real-time.

11. The matrix multiplier circuit of claim 1, wherein the circuit is constructed of 64(8×8) small multipliers.

12. The matrix multiplier circuit of claim 1, wherein the parallel counter circuitry is an arithmetic circuit including at least one borrow parallel counter and at least one 4-bit one-hot digital signal.

13. The matrix multiplier circuit of claim 1, wherein said circuit is utilized for size-4 matrix operations critical to graphics processing.

14. The matrix multiplier circuit of claim 1, wherein borrow parallel counter 5_1 and 5_1_1 circuits are provided, which results in increase of speed and testing ability of the circuit and in decrease of power consumption and area of implementation.

15. The matrix multiplier circuit of claim 4, wherein said single embedded full adder circuit achieves high performance while expending low-power.

16. A method of using a reconfigurable matrix multiplier circuit for generating a product of at least two matrices, said circuit comprising a plurality of matrix multipliers, an arithmetic circuit including at least one borrow parallel counter and at least one 4-bit one-hot digital signal, and a reconfiguration mechanism for computing the product of said two matrices, the method comprising the steps of:
receiving a plurality of input bit items;
duplicating said items and distributing said duplicated plurality of items to a plurality of base multipliers; and
setting states of reconfiguration switches to perform:
adding of partial products to create a plurality of results, and
accumulating the plurality of results.

17. The method of claim 16, wherein matrices being multiplied are of a form X(h×h), and Y(h×h), bitwidth of said input items is b-bit, and said method is performed on combinations of h-b pairs selected from 4-8, 2-16 and 1-32.

18. The method of claim 17, wherein the product of XY is produced when a column from the matrix X and a row from the matrix Y are operated upon in each pipeline step of the reconfigurable matrix multiplier circuit.

19. A borrow parallel counter includes 6 input bits, the counter comprising:
a borrow parallel counter circuit selected from borrow parallel counter 5_1 or 5_1_1 circuits; and
a 3:2 shift switch parallel counter circuit.

20. The borrow parallel counter of claim 19, wherein all 6 input bits of the borrow parallel counter are weighted 1, said counter being called a borrow parallel counter 6_0.

21. The borrow parallel counter of claim 19, wherein 5 input bits of the borrow parallel counter are weighted 1 and 1 input bit is weighted 2, said counter being called a borrow parallel counter 6_1.

22. A method of producing a reconfigurable matrix multiplier, the method comprising the following steps:
providing a partial product generator;
selecting a multiplier from a library, wherein said library comprises a plurality of small multipliers, each of said multipliers including at least one borrow parallel counter selected from one of borrow parallel counter 5_1, 5_1_1, 6_0, and 6_1 circuits and at least one shift switch parallel counter selected from one of 3:2 and 2:2 shift switch parallel counters for reducing partial products to two numbers; and
providing a one stage carry look-ahead adder with a carry propagate node.

23. The method of claim 22, wherein said 3:2 shift switch parallel counter further includes 24 transistors and a double-rail output S, for generating S complement without the use of an inverter.

24. The method of claim 22, wherein one or more of said small multipliers of said library process input ranging from 3 to 9 bits

25. A reconfigurable matrix multiplier comprising:
a partial product generator;
a multiplier selected from a library of multipliers, wherein said library comprises a plurality of small multipliers, each of said multipliers including at least one borrow parallel counter selected from one of borrow parallel counter 5_1, 5_1_1, 6_0, and 6_1 circuits and at least one shift switch parallel counter selected from one of 3:2 and 2:2 shift switch parallel counters for reducing partial products to two numbers; and
a one stage carry look-ahead adder with a carry propagate node.

26. The method of claim 25, wherein said 3:2 shift switch parallel counter further includes 24 transistors and a double-rail output S, for generating S complement without the use of an inverter.

27. The method of claim 25, wherein one or more of said small multipliers of said library process input ranging from 3 to 9 bits.
